(19) United States
(12) Patent Application Publication
(10) Pub. No.: US 2018/0229163 A1
(43) Pub. Date: Aug. 16, 2018

(54) FILTER SYSTEM

(71) Applicant: QINGDAO ECOPURE FILTER CO., LTD., QINGDAO (CN)

(72) Inventor: Zou Zhibin, Qingdao (CN)

(73) Assignee: QINGDAO ECOPURE FILTER CO., LTD., QINGDAO (CN)

(21) Appl. No.: 15/955,551

(22) Filed: Apr. 17, 2018

Related U.S. Application Data
(63) Continuation-in-part of application No. 15/166,231, filed on May 26, 2016.
Application No. 15/166,231 is a continuation-in-part of application No. 29/564,197, filed on May 11, 2016, now abandoned.
Application No. 29/564,197 is a continuation-in-part of application No. 29/564,270, filed on May 11, 2016, now abandoned.
Application No. 29/564,270 is a continuation-in-part of application No. 29/564,262, filed on May 11, 2016, now abandoned.
Application No. 29/564,262 is a continuation-in-part of application No. 29/564,255, filed on May 11, 2016, now abandoned.
Application No. 29/564,255 is a continuation-in-part of application No. 15/194,441, filed on Jun. 27, 2016, now abandoned.
Application No. 15/194,441 is a continuation-in-part of application No. 15/166,231, filed on May 26, 2016.
Application No. 15/166,231 is a continuation-in-part of application No. 15/200,697, filed on Jul. 1, 2016.
Application No. 15/200,697 is a continuation-in-part of application No. 15/945,234, filed on Apr. 4, 2018.

(30) Foreign Application Priority Data
Apr. 22, 2016 (EP) 3081181
Apr. 28, 2016 (CN) 2016301513029
Apr. 28, 2016 (CN) 2016301513033

(51) Int. Cl. B01D 35/157; B01D 35/02; B01D 29/56; C02F 1/00

(52) U.S. Cl. CPC B01D 35/1573; B01D 35/02; B01D 29/56; C02F 2101/20; B01D 2201/16; B01D 2201/303; B01D 2201/4061; C02F 1/003

(57) ABSTRACT

A fluid filter system is disclosed for filtering heavy metals. The filter system including a filter located outside of an appliance for removing heavy metals and a filter within the appliance that is downstream from filter from the having a filter for removing the heavy metals. The filter cartridge within the appliance holding a valve open that is on the filter head in the appliance.

### CROSS-REFERENCE TO RELATED APPLICATIONS

This Application is a continuation-in-part of U.S. patent application Ser. No. 15/166,231 (Docket NO. CO-1), entitled “Reusable Filter System,” by Zhibin Zou, filed May 26, 2016, which is incorporated herein by reference, which in turn is a continuation-in-part of

U.S. patent application Ser. No. 29/564,197 (Docket No. CO-2), entitled “Filter Unit,” by Zhibin Zou, filed May 11, 2016,

U.S. patent application Ser. No. 29/564,255 (Docket No. CO-3), entitled “Filter Unit,” by Zhibin Zou, filed May 11, 2016,

U.S. patent application Ser. No. 29/564,262 (Docket No. CO-4), entitled “Filter Unit,” by Zhibin Zou, filed May 11, 2016, and

U.S. patent application Ser. No. 29/564,270 (Docket No. CO-5), entitled “Filter Unit,” by Zhibin Zou, filed May 11, 2016;

this application is a continuation-in-part of U.S. patent application Ser. No. 15/194,441 (Docket No. CO-6), entitled “Reusable Filter System,” by Zhibin Zou, filed Jun. 27, 2016, which is a continuation-in-part of U.S. patent application Ser. No. 15/166,231 (Docket No. CO-1), entitled “Reusable Filter System,” by Zhibin Zou, filed May 26, 2016, which in turn is a continuation-in-part of

U.S. patent application Ser. No. 29/564,197 (Docket No. CO-2), entitled “Filter Unit,” by Zhibin Zou, filed May 11, 2016,

U.S. patent application Ser. No. 29/564,255 (Docket No. CO-3), entitled “Filter Unit,” by Zhibin Zou, filed May 11, 2016,

U.S. patent application Ser. No. 29/564,262 (Docket No. CO-4), entitled “Filter Unit,” by Zhibin Zou, filed May 11, 2016, and

U.S. patent application Ser. No. 29/564,270 (Docket No. CO-5), entitled “Filter Unit,” by Zhibin Zou, filed May 11, 2016;

this application is a continuation-in-part of U.S. patent application Ser. No. 15/200,697 (Docket No. CO-10), entitled “Water Filter,” by Zhibin Zou, filed Jul. 1, 2016;

this application is a continuation-in-part of U.S. patent application Ser. No. 15/945,234 (Docket No. CO-22), entitled “Filter System,” by Zhibin Zou, filed Apr. 4, 2018;.

All of the above Applications are incorporated herein by reference.

### FIELD

This specification relates generally to the purification of fluids.

### BACKGROUND

The subject matter discussed in the background section should not be assumed to be prior art merely as a result of its mention in the background section. Similarly, a problem and the understanding of the causes of a problem mentioned in the background section or associated with the subject matter of the background section should not be assumed to have been previously recognized in the prior art. The subject matter in the background section may merely represent different approaches, which in and of themselves may also be inventions.

Fluid filter systems remove impurities from fluid, such as water, so as to fulfill various requirements (e.g., for drinking purpose, medical use, industrial use, etc.). This specification recognizes the need for operating various filter systems without the filter present.

The size of a filter cartridge, and lifetime of filter cartridge may be limited by the environment in which the filter cartridge is intended to operate. For a filter cartridge that is of an appropriate size for installation within a refrigerator, the life time for which the filter cartridge remains effective in reducing heavy metal, may only be 200 or 300 gallons, which may mean that the filter will need to be changed in a very short time.

### BRIEF DESCRIPTION OF THE FIGURES

In the following drawings, like reference numbers are used to refer to like elements. Although the following figures depict various examples of the invention, the invention is not limited to the examples depicted in the figures.

FIG. 1 shows a diagram of an embodiment of a fluid filter system.

FIG. 2 shows an exploded view of an embodiment of the filter system of FIG. 1.

FIG. 3 shows a perspective view of an embodiment of the bottom of the filter head of FIG. 1.

FIG. 4A shows a back view of an embodiment of the filter head of FIG. 1.

FIG. 4B shows a side view of an embodiment of the filter head of FIG. 1.

FIG. 4C shows a front view of an embodiment of the filter head of FIG. 1.

FIG. 5 shows a bottom view of an embodiment of the filter head of FIG. 1.

FIG. 6 shows a top view of an embodiment of filter head of FIG. 1.

FIG. 7A shows a top perspective view of an embodiment of a manifold of the filter head of FIG. 1.

FIG. 7B shows a bottom perspective view of an embodiment of manifold of the filter head of FIG. 1.

FIG. 7C shows an enlarged front view of an embodiment of a tubular ring that may be used in the filter head of FIG. 1.

FIG. 8 shows a cross section of an embodiment of filter head of FIG. 1.

FIG. 9 shows a top perspective view of an embodiment of the filter cartridge of FIG. 1.

FIGS. 10A and 10B show side views of an embodiment of filter cartridge of FIG. 1.

FIG. 11 shows a top view of an embodiment of the cartridge cover of the filer cartridge of FIG. 1.

FIG. 12 is a bottom view of an embodiment of the canister of the filter cartridge of FIG. 1.

FIG. 13 shows a perspective view of an embodiment of the filter cover of the filter cartridge of FIG. 1.

FIG. 14 shows a perspective view of an embodiment of filter element of the filter cartridge of FIG. 1.

FIGS. 15A and 15B show a cross section of an embodiment of an empty filter cartridge.

FIGS. 16A-C shows different cross sections of an embodiment of the filter system of FIG. 1.

FIG. 17 shows a perspective view of o-ring that may be used with the filter system of FIG. 1.

FIGS. 18 and 19 show an embodiment of a refrigerator filter system that includes the filter system of FIG. 1.

FIG. 20 is a flowchart of an embodiment of a method of using the fluid filter system of FIG. 1.

FIG. 21 is a flowchart of an embodiment of a method of making the fluid cartridge of FIG. 1.

FIG. 22 is a flowchart of an embodiment of a method of making the fluid filter system of FIG. 1.

FIG. 23 shows another embodiment in which a plug is attached to the inside filter head instead of the inside filter cartridge of FIGS. 1-15B.

FIG. 24 shows a first cross sectional view of an embodiment of the plug attached to the filter head.

FIG. 25 shows a second cross sectional view taken along a cut line that is perpendicular to that of the FIG. 24 of an embodiment of the plug attached to the filter head.

FIG. 26 shows a side view of an embodiment of the plug.

FIG. 27 shows a second cross sectional view taken along a cut line that is perpendicular to that of the FIG. 24 of an embodiment of the plug attached to the filter head.

FIG. 28 shows the cross sectional view of the outside filter of FIG. 18.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

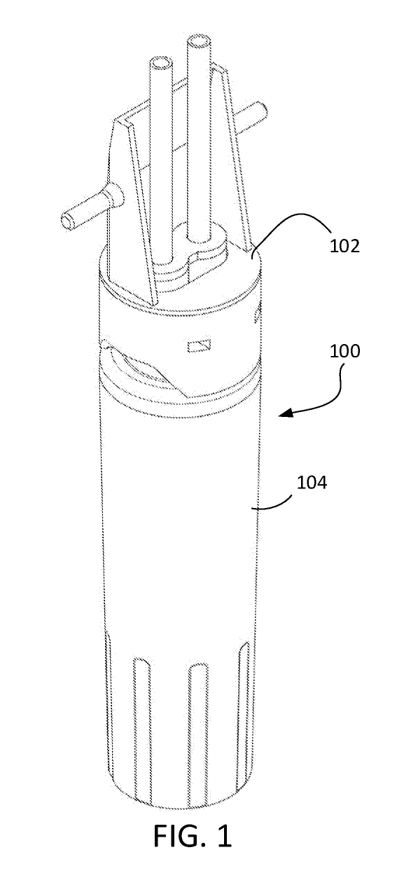

In general, at the beginning of the discussion of each of FIGS. 1-28 is a brief description of each element. After the brief description of each element, each element is further discussed, usually in numerical order. Additionally, in various locations, headings are used to improve the readability of the application. However, despite the organizational features of the application, such as the headings and the discussion of each element in numerical order, there is no one location where all of the information of any element of FIGS. 1-28 is necessarily located. Unique information about any particular element or any other aspect of any of FIGS. 1-28 may be found in, or implied by, any part of the specification.

FIG. 1 shows a diagram of an embodiment of a fluid filter system 100. The fluid filter system 100 includes at least filter head 102 and filter cartridge 104. In other embodiments, the fluid filter system 100 may not include all of the components listed and/or may include other components in addition to or instead of those listed above.

In at least one embodiment, the fluid filter system 100 (which may be referred to as a water filter assembly) includes an optional filter element, and may be operated without the filter element. In at least one embodiment, a cartridge filter that does not have a heavy metal reduction filter media inside is installed. In an embodiment, a toxic heavy metal may be any relatively dense metal or metalloid that is noted as potentially being toxic. Some examples of heavy metals are cadmium, mercury, lead, and arsenic. Other examples of heavy metals are beryllium, aluminum, chromium, manganese, iron, cobalt, nickel, copper, zinc, arsenic, selenium, molybdenum, silver, cadmium, tin, antimony, barium, mercury, thallium, and lead.

The function of the cartridge may only be to hold open the shut off valve of filter head or stop fluids from leaking to the refrigerator if there is no valve to prevent leaks. In an embodiment, there is a fluid filter system outside the refrigerator and connected to the fluid source at the inlet end of the filter outside of the refrigerator and is connected to the fluid inlet of the refrigerator at the outlet end of the filter outside of the refrigerator. In this specification, the words “refrigerator,” “fridge,” and “appliance” are used interchangeably. Any of these words may be substituted for another of these words in any location of the specification to get a different embodiment. In this specification, the words “fluid” and “water” are used interchangeably. Either word may be substituted for the other in any location of the specification to get a different embodiment.

The filter outside of the refrigerator has a longer lifetime during which the filter is effective in reducing heavy metals (and/or other substances) in the water (and/or other fluids). The filter outside of the refrigerator is more effective in removing heavy metals (and/or other substances) than the filter in the refrigerator. In other words, a manner of improving a refrigerator water filter system, may include installing a filter cartridge or filter element in a filter cartridge (e.g., where the filter element does not reduce heavy metals) in the filter head of the refrigerator, and also installing a second water filter system that is effective in filtering heavy metals, which is connected between the water source (e.g., the water source for the home or from the refrigerator) and the water inlet of the refrigerator. The water cartridge installed in the refrigerator (and/or outside of the refrigerator) may have a filter material that improves the functioning of the water filter system.

For example, the user may own a refrigerator (or other appliance) that includes a water filter. However, the filter system that comes with the refrigerator may have a small filter element that needs to be replaced frequently or may not purify water as well as the user may desire. Accordingly, the user installs a separate filter that is larger and/or a higher quality filter between a water source and the refrigerator at the water inlet to the refrigerator (the “water inlet” being the end of the pipe, tube, or other conduit where water enters the appliance) and/or for the entire household. It may be desirable for a filter head to have a shutoff valve, so that if the user does not shutoff the water to the refrigerator when changing the filter cartridge, the water does not pour all over the floor. Additionally, the filter head may be designed so that the user can change the filter cartridge without shutting off the water to the water dispenser. However, if the filter head has a shutoff valve, the refrigerator's water dispenser may not function without a filter cartridge present. Accordingly, the filter cartridge without the heavy reduction filter element is installed to keep the filter head open, while the filter outside of the refrigerator filters the water.

The filter head 102 is the top portion of filter system 100 installed within the refrigerator. The filter head 102 is attached to the inlet conduits and outlet conduits of the refrigerator and is mounted on the refrigerator. Fluid, from which heavy metals (and/or other substances) have been removed by the external filter, enters filter system 100, via an inlet of the filter head 102, into filter system 100 for optional further purification, and the further purified fluid from within the filter system 100 exits filter system 100 into the outlet conduit of the refrigerator (e.g., a water dispenser). Unless stated otherwise, when discussing filter system 100, the unpurified fluid, refers to fluid from which heavy metals (or other substances intended to be removed by the outer filter) has been removed by the external filter, but the fluid has not been further purified by filter system 100. Filter head 102 includes valves that open when a filter cartridge is attached and are shut off when the filter cartridge is removed.

Filter cartridge 104 is connected to the filter head 102 and holds the filter element. Filter cartridge 104 is held in the refrigerator by filter head 102. Filter cartridge 104, when installed keeps valves in the filter head 102 open and thereby may be referred to as a “by-pass cartridge.” Filter cartridge 104 may be removably attached to filter head 102. In this specification, the terms “removable,” “removably,” and “detachable” refer to being easily removable by hand (e.g., without tools). In this specification, terms “removable,” “removably,” and “detachable” may be substituted one for another to obtain different embodiments. Unpurified fluid from the filter head 102 enters filter cartridge 104, passes through the filter element, thereby being purified, while within filter cartridge 104, and then exits filter cartridge 104 into the filter head 102. Filter cartridge 104 holds the filter element that filters the fluid (or the filter cartridge 104 may be empty). When the filter element needs to be replaced, the user may replace filter cartridge 104.

In this specification, the terms “top,” “bottom,” “up,” and “down” refer to what is the top, bottom, up and down, when the filter system 100 is oriented in the orientation of FIG. 1. However, filter system 100 may be installed in any orientation, such as what would be considered sideways, upside down, etc. from the point of view of the orientation of Filter system 100 of FIG. 1.

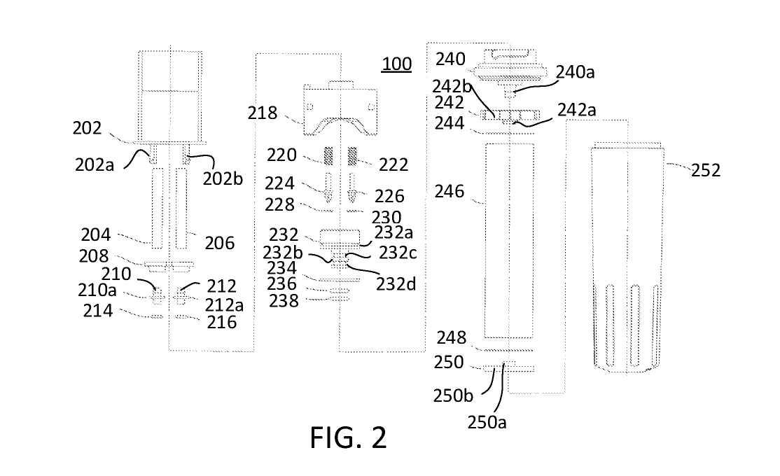

FIG. 2 shows an exploded view of an embodiment of the filter system 100. The filter system 100 includes at least a guard 202 having legs 202a and 202b, input conduit 204, output conduit 206, mask 208, tubular rings 210 and 212 having collars 210a and 212a, respectively, o-rings 214 and 216, manifold 218, springs 220 and 222, plugs 224 and 226, o-rings 228 and 230, fluid distributor 232 having neck 232b, o-rings 234, 236, and 238, cartridge cover 240 having neck 240a, top cap 242 having neck 242a, filter cover 244, filter element 246, filter cover 248, bottom cap 250 having tubular extension 250a and wall 250b, and canister 252. In other embodiments, the fluid filter system 100 may not include all of the components listed and/or may include other components in addition to or instead of those listed above.

Guard 202 guards the input and output conduits and attaches to the refrigerator, so as to attach the filter head to the refrigerator. Legs 202a and 202b attach to the conduit and hold the input conduit and output conduit to the manifold. In an embodiment legs 202a and 202b include tabs or other protrusions that attach to holes or depressions in the wall of the manifold. In an embodiment, guard 202 has four legs, and in FIG. 2 two of the legs are hidden from view by legs 202a and 202b, and the collection of four legs may be referred to collectively as legs 202a-d (although legs 202c and 202d are hidden from view in FIG. 2). In other embodiments there may be a different number of legs other than 4. For example, guard 202 may have one, two, three, five, six, seven, eight, or another number of legs.

Input conduit 204 connects to the input conduit of the refrigerator at one end and to the manifold of filter system 100 at another end of input conduit 204. The fluid entering input conduit 204 has been filtered by the outside filter, which has removed heavy metals from the fluid. Optionally or additionally, input conduit 204 may include a pin (or other protrusion) that automatically opens a valve on the input conduit of the refrigerator. Fluid from the input conduit of the refrigerator travels through input conduit 204 into the filter head 102 of filter system 100.

Output conduit 206 connects to the output conduit of the refrigerator at one end and to the manifold of filter system 100 at another end of output conduit 206. Optionally or additionally, output conduit 206 may include a valve that automatically opens when connected to the output conduit of the refrigerator. Fluid from the filter system 100 travels through output conduit 206 into the output conduit of the refrigerator, such as for being dispensed, via a water dispenser. Input conduit 204 and output conduit 206 may be held in place with the aid of guard 202. In an embodiment input conduit 204 and output conduit 206 are hollow tubes, which optionally may be flexible.

Mask 208 may be a plate with two holes through which input conduit 204 and output conduit 206 protrude. Mask 208 rests on the top of a manifold to which mask 208 is attached. Mask 208 may aid in holding conduits 204 and 206 to the manifold. In an embodiment, tubular rings 210 and 212 are tubular in shape and each have a flange or collar between the each of the ends of the rings 210 and 212 and a bulge at one end. The tubular rings 210 and 212 are inserted into the holes of mask 208, with the end having the bulge on one end of mask 208, facing the input conduit 204 and output conduit 206, and the flange on the other end of mask 208 is located further away from input conduit 204 and output conduit 206. The bulge on ring 210 is inserted into one end of output conduit 206 and the bulge on ring 212 is inserted into one end of input conduit 204. Once input conduit 204 and output conduit 206 are connected to the bulges on tubular rings 210 and 212, and the flanges on tubular rings 210 and 212 prevent input conduit 204 and output conduit 206, respectively, from being pulled away from the filter head in the direction pointing away from tubular rings 210 and 212.

O-rings 214 and 216 are placed on tubular rings 210 and 212 and/or at one end of tubular rings 210 and 212, between tubular rings 210 and 212 and the manifold and form a fluid-tight seal between tubular rings 210 and 212 and the corresponding holes in the manifold.

Manifold 218 serves as a structure to which other parts of the filter head may be attached. The ends of tubular rings 210 and 212 that are furthest from the mask 208 and input conduit 204 and output conduit 206 (which have o-rings 210 and 212) are inserted into matching holes in manifold 208. Tubular rings 210 and 212 are sandwiched between mask 208 and manifold 218. Mask 208 may be adhered to manifold 218, such as by an adhesive, glue, solder, welding, and/or by melting mask 208 to manifold 218. The legs 202a and 202b attach to holes on indentations in walls of manifold 218, thereby holding guard 202 to manifold 218.

Springs 220 and 222 mechanically bias outlet valves into a closed position. In an embodiment, springs are inserted into wells in manifold 218. Plugs 224 and 226 plug up the openings in the manifold 218 preventing fluid entering the filter cartridge 104, and thereby preventing fluid from flowing when the filter cartridge 104 is not attached. One end of plugs 224 and 226 is pushed by springs 220 and 222 towards holes through which fluid flows biasing plugs 224 and 226 to a closed position in which no fluid flows. In an embodiment, plugs 224 and 226 are pegs having one end rounded or pointy (which is inserted into holes in fluid distributor) and one end of plugs 224 and 226, which is flat, are inserted into springs 220 and 222, which are in-turn inserted into wells in the manifold 218. The end of plugs 224 and 226 that is furthest from springs 220 and 222 may be the pointy or rounded ends for guiding plugs 224 and 226 in the holes that plugs 224 and 226 closed when in the closed position. Plugs 224 and 226 may also have a disc at the collar at the base of the pointy region, and the disc shaped collar may cover the holes being plugged when plugs 224 and 226 are in the closed position.

O-rings 228 and 230 line the hole that plugs 224 and 226 close, so as to form a fluid tight seal and block fluids from flowing and leaking when plugs 224 and 226 plug the holes associated with the plugs 224 and 226. Fluid distributor 232 receives fluid from manifold 218 and distributes the incoming fluid into the sides the filter cartridge. Springs 220 and 224 bias plugs 224 and 226, pushing the plugs 224 and 226 into holes in fluid distributor 232 to stop the flow of fluid from fluid distributor 208 into the filter cartridge 104. Springs 220 and 222, plugs 224 and 226, and wells in manifold 218 that hold springs 220 and 224 and the openings in fluid distributor that the plugs plug up, form two inlet valves that are opened by attaching filter cartridge 104. Manifold 218 and fluid distributor 232, when connected to one another, form a first channel that distributes incoming fluids from input conduit 204 to the two holes in fluid distributor 232 that are plugged by plugs 224 and 226 when filter cartridge 104 is installed. Similarly, manifold 218 and fluid distributor 232, when connected to one another, form a second channel, via which outgoing fluids leave filter cartridge 104 are directed toward output conduit 206. Fluid distributor 232 includes groove 232a for an o-ring. Neck 232b carries outgoing fluids from filter cartridge 104 to output conduit 206, and has two grooves 232c and 232d for o-rings. O-ring 234 fits in groove around the largest diameter of fluid distributor 232 in groove 232a. O-ring 234 prevents incoming fluids from leaking out of the filter system 100. O-rings 236 and 238 fit on grooves 232c and 232d. O-rings 236 and 238 prevent the mixing of incoming and outgoing fluids.

In one embodiment, the top o-rings 214, 216, 228, 230, 234, 236, and/or 238 may be made of rubber, silicon, or any other soft and/or resilient fluid tight materials. In an embodiment, any of the o-rings of this specification may be made from any gummy, rubbery material, elastomer, nonporous, and/or flexible material that prevents fluids from leaking. Some non-limiting examples of materials that may be used for the O-rings are natural rubber, polyacrylate rubber, ethylene-acrylate rubber, polyester urethane, bromo isobutylene isoprene bromobutyl, polybutadiene buna, chloro isobutylene isoprene chlorobutyl, buty polychloroprene chloroprene, neoprene, chlorosulphonated polyethylene hypalon, epichlorohydrin, epichlorohydrin, epichlore, epichloridrine, herclor, hydrin, ethylene propylene, ethylene propylene diene monomer, nordel, polyether urethane, perfluorocarbon rubber, kalrez, chemraz, fluoronated hydrocarbon viton, fluorel, fluoro silicone, silicone rubber, fluorocarbon rubber, hydrogenated nitrile butadiene, polyisoprene (synthetic) natural rubber, isobutylene isoprene butyl butyl, acrylonitrile butadiene, nitrile, perbunan, buna-N, polyurethane, polyurethane, styrene butadiene, buna-S, GRS, buna VSL, buna SE, styrene ethylene butylene styrene copolymer rubber, polysiloxane silicone rubber, vinyl methyl silicone, silicone rubber, acrylonitrile butadiene carboxy monomer, carboxylated nitrile, styrene butadiene carboxy monomer, thermoplastic polyether-ester, styrene butadiene block copolymer, and/or styrene butadiene carboxy block copolymer.

Cartridge cover 240 is the cover to the filter cartridge 104. Cartridge cover 240 covers opens the holes otherwise plugged by plugs 224 and 226. Once open, incoming fluids from the holes (that are otherwise plugged by plugs 224 and 226) flow holes into the sides of cartridge cover 240, and outgoing fluids leaves cartridge cover 240 through a hole in the center of the cartridge cover 240 to the neck 232b of fluid distributor 232. Neck 232b mates with a hole in filter cover 240. Neck 240a of cartridge cover 240 mates with a hole in the top cap of the filter element.

Top cap 242 distributes the incoming, unpurified fluid around the outside of the filter element within the filter cartridge 104. Top cap 242 has a generally plate shaped base and a neck 242a. Neck 240a mates with a hole in the filter cover and filter element receives the neck 232b of filter distributor 232. Unpurified fluid enters the cartridge cover 240 on the outside of the top cap 242, while purified fluid leaves the filter element through the center of the neck 242a of top cap 242 to neck 232b of filter distributor 232. Walls 242b extend downwards covering the sides of filter cover and the top of the sides of filter element.

Filter cover 244 may be a flat disc with a whole in the center. Filter cover 224 covers the filter element and is located between the filter element and the bottom of the top cap 242. Filter cover 224 helps prevent fluids from exiting the filter element out of the flat top of the filter element thereby helping to force the fluid to travel from the outer side walls surfaces of the filter element through the filter element and exiting the filter element through the surface of the inner walls of the filter element. Filter cover 244 may receive neck 242a of filter cap 242.

Filter element 246 is made from a material that may purify fluid, but does not remove heavy metals (instead the outside filter removes the heavy metals). In an embodiment, filter element 246 includes a hollow core into which seep from outside filter element 246, under pressure from incoming fluid. Filter element 246 filters the fluid, just after the fluid has been pumped into filter system 100 into a location in filter system 100 just outside of the filter element 246. After the fluid seeps from just outside filter element 246, through the walls of filter element 246, into the hollow core or cavity within filter element 246, the fluid from the hollow core travels, via the opening of the hollow core in the filter element 246, out of the filter element 246 into the bottom of top cap 242 and up the inside of the neck of top cap 242. In this specification the term “hollow core” and “cavity” are used interchangeably and either may substituted for the other throughout this specification. In an embodiment, filter element 246 is cylindrical and has an opening into the hollow core and the hollow core is a cylindrical channel running through the center of the filter element 246. In an embodiment, the hollow core of filter element 246 is optionally cylindrical and is concentric with the outer surface of filter element 246. In an embodiment, filter element 246 includes an inner channel that is open on both ends, allowing more fluid to fill the hollow core and be purified by filter element 246. In other embodiments, filter element 246 may have other shapes, such as rectangular square, or spherical, and/or the opening has a different shape than the rest of the hollow core. Similarly, in another embodiment, filter element 246 may be open on only one end. In another embodiment, filter element 246 may be an element that blocks the flow in a pipe, forcing the fluids to flow through the filter element 246 to pass through the pipe. Walls 242b of top cap 242 extend downwards covering the sides of filter cover 244 and the top of the sides of filter element 246.

Filter cover 248 covers the bottom of the filter element 246 (which is the end of the filter element 246 that is furthest from the filter cover 222). In an embodiment, filter cover 248 is a flat disc similar to filter cover 244, which optionally has a whole in the center for engaging a protrusion in a bottom cap. Filter cover 248 covers the opposite end of filter element 246 than the end of filter element 246 that filter cover 244 covers, and is located between the filter element 246 and the bottom cap. Filter cover 248 helps prevent fluids from exiting filter element 246 from the flat bottom of the filter element 246, thereby helping to force the fluid to travel from the outer side walls surfaces of the filter element 246 through the filter element 246 and exiting the filter element 246 through the surface of the inner walls of the filter element 246.

In an embodiment, when filter cartridge 104 is assembled, the filter element 246 may be under a slight amount of pressure (e.g., slightly compressed), being slightly squeezed, or snuggly fit, between the filter cover 244 and a second filter cover 248, which are at the opposite ends of filter element 246. The slight pressure that may be required to fully install the filter element 246 holds filter element 246 and to filter covers 226 and 228, and thereby prevents unfiltered fluid from bypassing the filter element 246 to entering the hollow core of the filter element 246.

Bottom cap 250 attaches to the bottom of filter element 246 and holds filter cover 248 to the bottom of filter element 246. Bottom cap 250 is located at the opposite end of filter element 246 as fluid distributor 226 and top filter cover 224. In an embodiment, tubular extension 250a extends up through the hole in filter cover 248 into hollow core of filter element 246. Walls 250b extend upwards covering the sides of filter cover 248 and the bottom of the sides of filter element 246.

Canister 252 attaches to cartridge cover 240. Together, canister 252 and cartridge cover 240 form the housing of filter cartridge 104. Top cap 242, filter cover 244, filter element 246, filter cover 248, and bottom cap 250 are held within canister 252 and cartridge cover 240. For example, filter cover 244, filter element 246, filter cover 248, and bottom cap 250 are located in canister 252, while neck 242a of fluid distributor 240 protrudes into cartridge cover 240. Any number of fasteners may be used to hold canister 252 to cartridge cover 240. For example, canister 252 may be welded or melted to cartridge cover 240. Canister 252 may be pressure fit to cartridge cover 224 or glued to canister cover 224. Alternatively, canister 252 may screw on to cartridge cover 234 or cartridge cover 234 and canister cover 224 may be held together with clasps or snaps. When canister 252 is attached to cartridge cover 234, a slight amount of pressure may be applied to press against bottom cap 250 and fluid distributor.

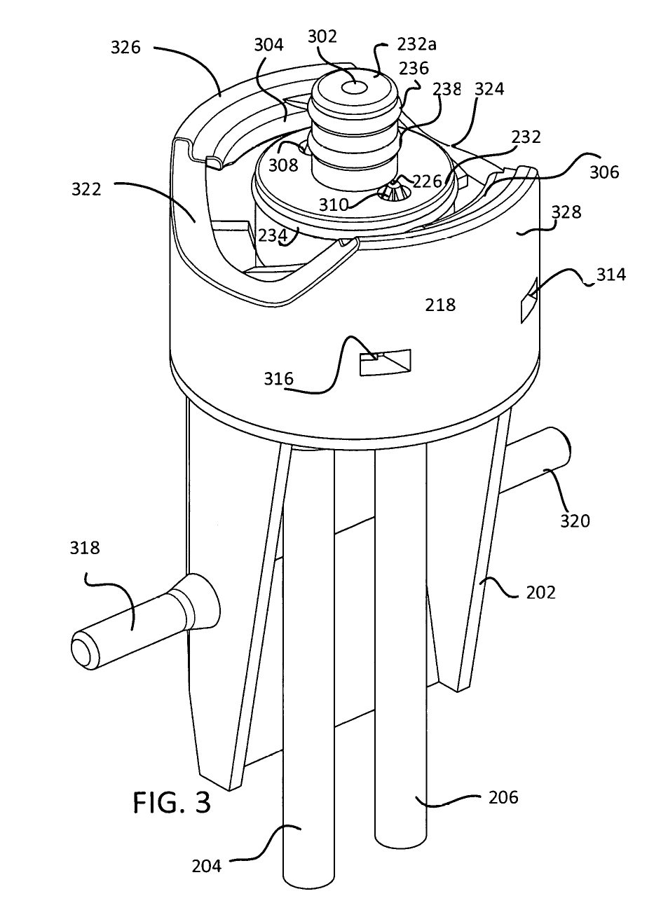

FIGS. 3-8 show details of the fully assembled filter head 102 and of manifold 206 (which were also shown in FIGS. 1 and 2). However, in other embodiments, filter head 104 and/or manifold 206 may not include all of the components disclosed and/or may include other components in addition to or instead of those disclosed in conjunction with FIGS. 1-6.

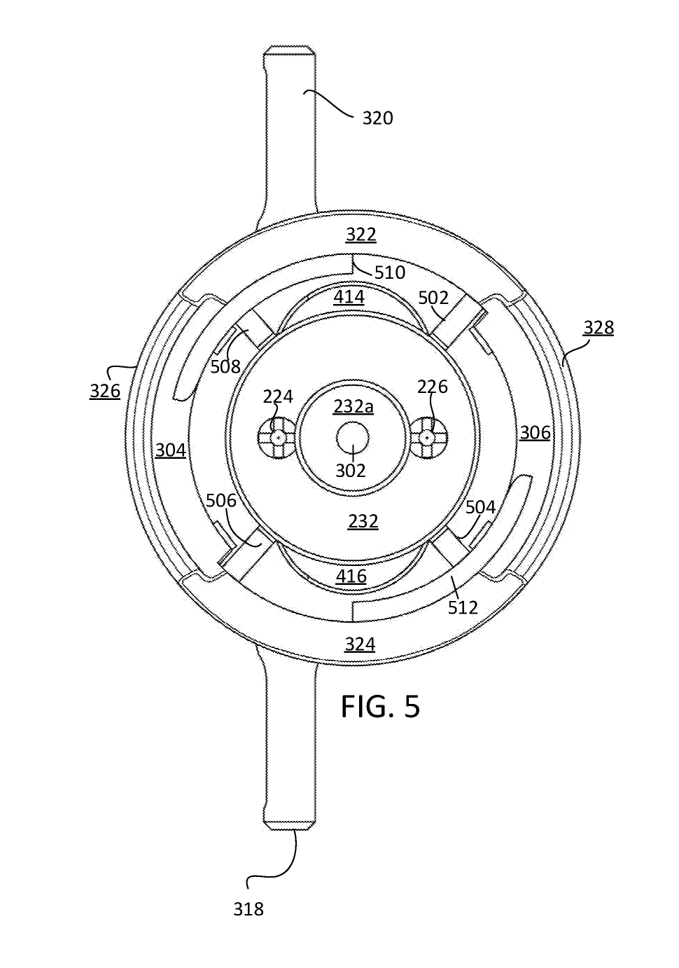

FIGS. 3 and 5 show manifold 218 (FIG. 3), plug 226, fluid distributor 232 having hole 302, flanges 304 and 306, arms 318 and 320, neck 232b, notches 322 and 324, and walls 326 and 328.

FIG. 3 shows a perspective view of an embodiment of the bottom of the filter head 102, including guard 202, input conduit 204, output conduit 206, manifold 218, plug 226, fluid distributor 232 having neck 232b, o-rings 234, 236, and 238. Neck 232b includes hole 302, manifold 218 includes flanges 304 and 306, holes 308, 310, 314 and 316. Guard 202 includes arm 318 and arm 320. Manifold 218 includes also notch 322, notch 324, wall 326, and wall 328.

In FIG. 3, input conduit 204 and output conduit 206 are attached to guard 202, which is attached to manifold 218, fluid distributor 232 is attached to manifold 218, and o-rings 234, 236, are attached to neck 232b and o-ring 238 is attached to the body of fluid distributor 232.

Hole 302 is located in the neck 232b of fluid distributor 232 (e.g., in the center of neck 232a), and carries fluid leaving filter cartridge 104, which later exits the filter system 100. Flanges 304 and 306 interlock with flanges on cartridge cover 240 to hold filter cartridge 104 onto filter head 102. Holes 308 and 310 are the holes that are plugged by plugs 224 and 226. In FIG. 3, the tip of plug 226 is visible through hole 310, but although hole 308 is partially visible, the tip of plug 224 is hidden from view by neck 232b. Holes 312 and 314 accept the tabs on legs 202a and 202b (FIG. 2) of guard 202, thereby holding guard 202 to manifold 218. In an alternative embodiment, legs 202a and 202b may have holes or depression that accept tabs on the inside of the walls of manifold 218. Arms 318 and 320 protrude from the sides of guard 202, are inserted into corresponding holes or notches on the refrigerator to hold filter head 102 in place, and mounted on the refrigerator. Notches 322 and notch 324 are cutouts between walls 326 and 328 formed by the space between walls 326 and 328. To connect filter cartridge 104 to filter head 102, the neck of the filter cartridge 104 is placed between walls 326 and 328, with protrusions on the neck of the filter cartridge 104 in notches 322 and 324, and then filter cartridge 104 is rotated so that the protrusions are guided on top of flanges 304 and 306, to hold filter cartridge 104 in place, so that filter cartridge 104 keeps plugs 224 and 226 open so that fluid flows between input conduit 204 and output conduit 206 (the protrusions on the neck of filter cartridge 104 are guided to be between flanges 304 and 306 and guard 202).

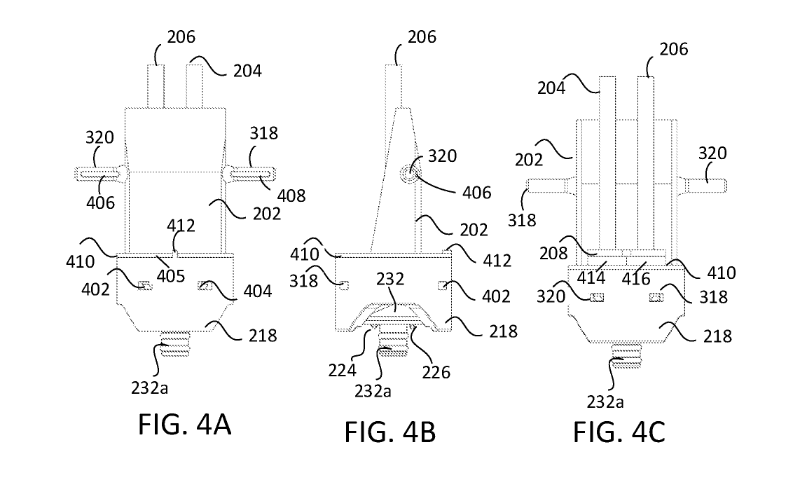

FIGS. 4A, 4B and 4C show different views of the filter head 102, which each include guard 202, input conduit 204 (FIGS. 4A and 4C), manifold 218, neck 232b (of fluid distributor 232), and arm 320. FIGS. 4A and 4B show output conduit 206, hole 402, bump 406, and base 410.

FIG. 4A shows a back view of the filter head 102, which also has hole 404 (in addition to hole 402), and bump 408 (in addition to bump 406). Holes 402 and 404 may accept the tabs on legs 202d and 202c (not visible in FIG. 2). In an embodiment, there are at least as many holes in manifold 218, for accepting the legs of guard 202, as there are legs on guard 202. Although in the embodiments of FIGS. 2-6, guard 202 has legs with tabs and manifold 218 have holes for accepting the tabs on the legs of guard 202. In other embodiments, guard 202 may have the holes and manifold 218 may have the legs. In an embodiment, the holes (e.g., holes 318, 320, 402, and 404) may be replaced with indentations that accept the tabs on the legs of guard 202.

Bumps 406 and 408 may help prevent guard 202 from rocking. Bumps 406 and 408 may be elongated cylindrical bumps extending the length of arms 318 and 320 or extending a majority of the length of arms 318 and 320 (e.g., 80% of the length of arms 318 and 320). Bumps 406 and 408 may be replaced with circular bumps or pins or another two arms perpendicular to arms 318 and 320 may be added to guards 202.

Base 410 is the base of guard 202, which covers the top of manifold 218, thereby protecting the structures within manifold 218 from dust, dirt, and damage. Legs 202a-202d may be attached to base 410. In other embodiments, the combination of legs and holes or indentations may be replaced with other fasteners, such as clasps, buckles, buttons, snaps, solder, rivets, screws, nail pegs, or other fasteners.

FIG. 4B shows a side view of an embodiment of the filter head 102, which includes hole 402 and tab 412. The right and left side views are mirror images of one another. FIG. 4B also shows hole 318 (in addition to hole 402). In FIG. 4B, the tips of both plugs 224 and 226 are visible, protruding through fluid distributor 232 (FIG. 2), via holes 308 and 310 (FIG. 3). Tab 412 is attached to (and part of) manifold 218. In an embodiment, tab 412 protrudes through a slot in base 410 to aid in aligning base 410 with manifold 218. In alternative embodiment, tab 412 may be located on base 410, and the walls of manifold 218 may be a slot that the tab fits into.

FIG. 4C shows a front view of the filter head 102 in which mask 208 is visible, which, in combination with guard 202 (and in combination with tubular rings 210 and 212, see FIG. 2), hold input conduit 204 and output conduit 206 in place. Wells 414 and 416 support, and are attached, to input conduit 204 and output conduit 206. Mask 208 rests on and is adhered (e.g., glued, welded, or soldered) to wells 414 and 416. In an alternative embodiment, manifold 218 is built symmetrically, with wells 414 and 416 halfway between the front and back of manifold 218, so that guard 202 may be attached to manifold 218 forwards or backwards.

FIG. 5 (like FIG. 3) shows plugs 224 and 226, fluid distributor 232 having hole 302, flanges 304 and 306, neck 323a, notches 322 and 324, and walls 326 and 328. FIG. 5 also shows struts 502, 504, 506, and 508, slopes 510 and 512, and wells 414 and 416.

Struts 502, 504, 506, and 508 are part of manifold 218 and support structures (such as wells 414 and 416 (FIG. 4C) in the center of manifold 218, which in turn supports fluid distributor 232.

Slopes 510 and 512 slope from flanges 304 and 306 (FIG. 3) downward further into manifold 218 and help guide protrusions in the neck of filter cartridge 104 under flanges 304 and 306, respectively. FIG. 5 shows a portion of the bottom of wells 414 and 416 (which is closed). Wells 414 and 416 support input conduit 204 and output conduit 206 and fluid distributor 232. Fluids may flow from input conduit 204 to one of wells 414 and 416 through holes 308 and 310, when holes 308 and 310 are not plugged by plugs 224 and 226. Another of wells 414 and 416 may carry fluids, via hole 312, from filter cartridge 104.

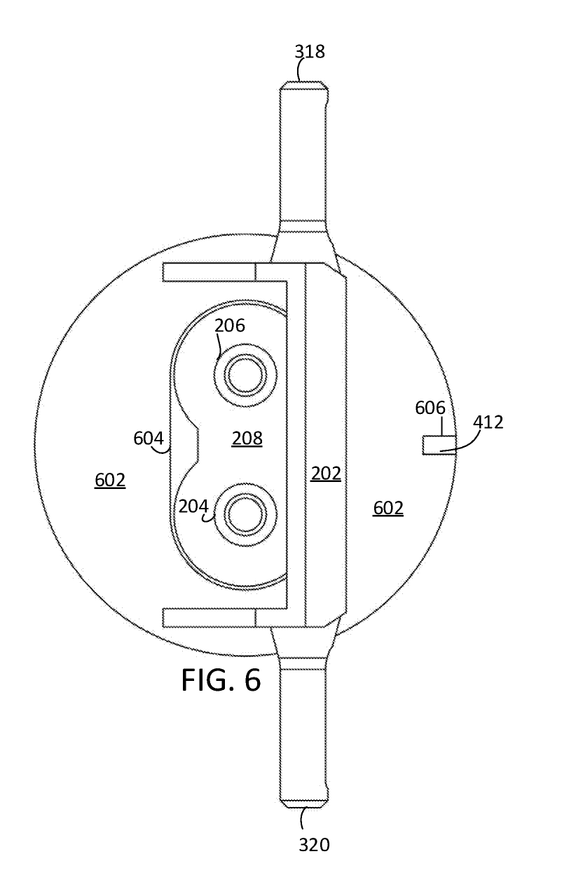

FIG. 6 shows a top view of an embodiment of filter head 102, which includes guard 202, input conduit 204, output conduit 206, and mask 208. Guard 202 includes base 602, opening 604, and slot 606. FIG. 6 also shows tab 412 of manifold 218 (FIG. 2). Base 602 may be an embodiment of base 410. Wells 414 and 416 (FIG. 4C) protrude through opening 604, but wells 414 and 416 are not visible in FIG. 6, because wells 414 and 416 are covered and hidden from view by mask 208 and input conduit 204 and output conduit 206. Slot 606 engages tab 412 (FIG. 4C) to help align guard 202 (e.g., so that guard 202 is not put on backwards).

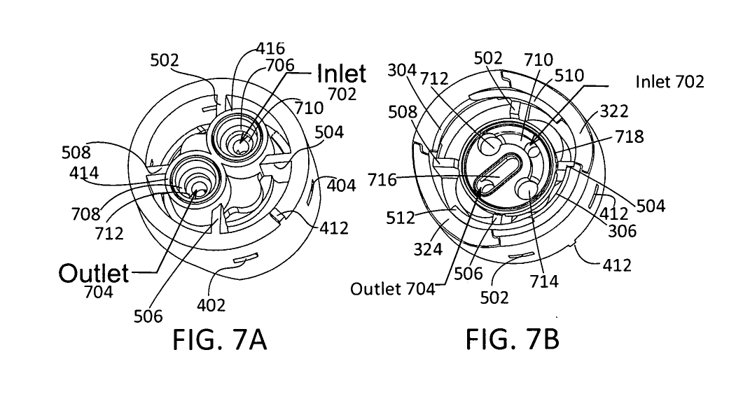

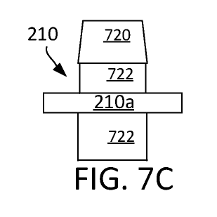

FIGS. 7A and 7B show an embodiment of manifold 218. Manifold 218 is also visible in FIGS. 1-6 as part of filter head 102.

FIG. 7A shows a top perspective view of manifold 218, which includes wells 414 and 416, which includes inlet channel 702, outlet channel 704, ledges 706, 708, 710, and 712 located within wells 414 and 416. Inlet channel 702 and outlet channel 704 are the channels within which fluids flow within wells 414 and 416, as manifold 218 transfers fluids between input conduit 204 and output conduit 106 and fluid distributor 232. Ledges 706 and 708 support the wide collars 210a and 212a surrounding tubular rings 210 and 212. Ledges 710 and 712 directly support, or support via o-rings 214 and 216, the end of tubular rings 210 and 212 that is furthest from input conduit 204 and output conduit 206.

FIG. 7B shows a bottom perspective view of manifold 218 and the bottom of inlet channel 702 and outlet channel 704. FIG. 7B also shows channel 710, wells 712 and 714, channel 716, and circular receptor 718.

Channel 710 transfers fluids from holes 308 and 310 to outlet channel 704. Wells 712 and 714 hold springs 220 and 222. When plugs 224 and 226 are retracted to allow fluids to flow, springs 220 and 222 are compressed and push against the bottom of wells 712 and 714. Channel 716 transfers fluids between outlet 704 and the neck 232b of fluid distributor 232. Circular receptor 718 includes channel 710, wells 712 and 714, channel 716, and circular receptor 718. Circular receptor 718 accepts fluid distributor 232. Fluid distributor 232 covers channels 710 and 716.

FIG. 7C shows a blow up of one of the tubular ring 210 having a collar 210a, tapered head 720, and body 722. Tapered head 720 has a top end at one opening of the tubular ring 210, which is narrower than the bottom of the tapered head 720, and the outer walls of tapered head 720 gradually tapers from having a width of bottom of tapered head 720 to the width of top of tapered head 720. Body 722 is the body of the tubular ring 210. Body 722 may be tubular in shape on both the inside and outside. Similarly, body 722 may be tubular in shape on both the inside and outside. In an embodiment, bottom of tapered head 720 (where tapered head meets body 720) is wider than body 722. Tubular ring 210 is identical of tubular ring 212. In an embodiment, the change in width of tubular ring 210 or 212 between bottom of tapered head 720 and the adjacent portion of body 720 is sudden, discontinuous, so as to tend to dig-in to the inner walls input conduit 204 and output conduit 206 when one attempts to pull tubular ring 210 or 212 out of input conduit 204 and output conduit 206. Top of tapered head 720 is narrower than the inner diameter of input conduit 204 and output conduit 206, and bottom of tapered head 720 is wider than the inner diameter of input conduit 204 and output conduit 206. As a result of the narrower end of tapered head 720, tubular rings 210 and 212 fit into at least one end of input conduit 204 and output conduit 206, and with some force, may be pushed further into input conduit 204 and output conduit 206. As a result of the bottom of tapered head 720 being wider than the inner diameter of input conduit 204 and output conduit 206, once the bottom of tapered head 720 is within output conduit 206 or input conduit 204, the tight fit holds tapered head 720 from leaving output conduit 206 or input conduit 204, and may form a fluid tight seal. In an embodiment, an average person is capable of inserting tubular rings 210 and 212 into input conduit 204 and output conduit 206, by hand, so that tubular rings 210 and 212 stay within input conduit 204 and output conduit 206 and form a seal, as a result of the tight fit (which may be referred to as a friction fit). In an embodiment, an average person is also capable of removing tubular rings 210 and 212, by hand, from input conduit 204 and output conduit 206, without damaging input conduit 204 and output conduit 206 or tubular rings 210 and 212 (despite the friction fit).

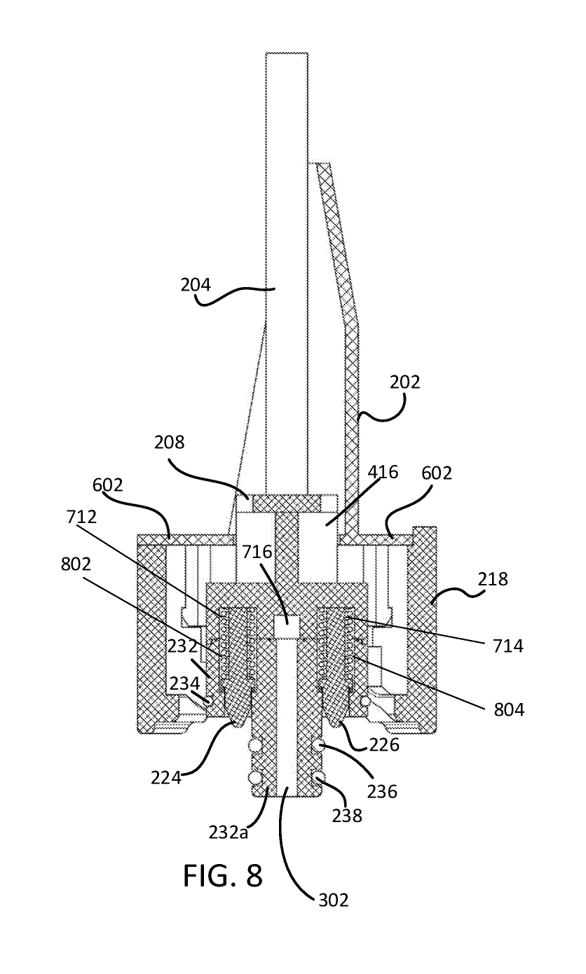

FIG. 8 shows a cross section of an embodiment of filter head 202, which shows a cross sectional view fluid distributor 232 having channels 802 and 804, together with wells 712 and 714, which house plugs 224 and 226, respectively.

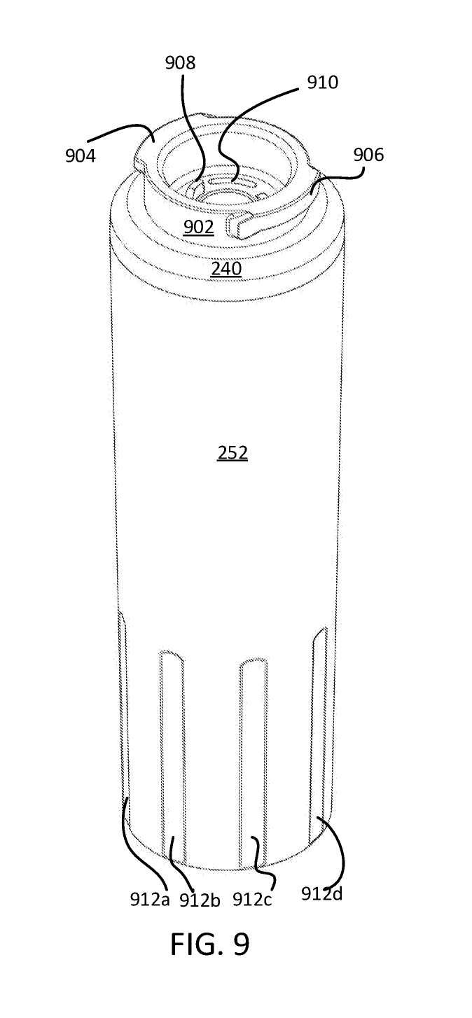

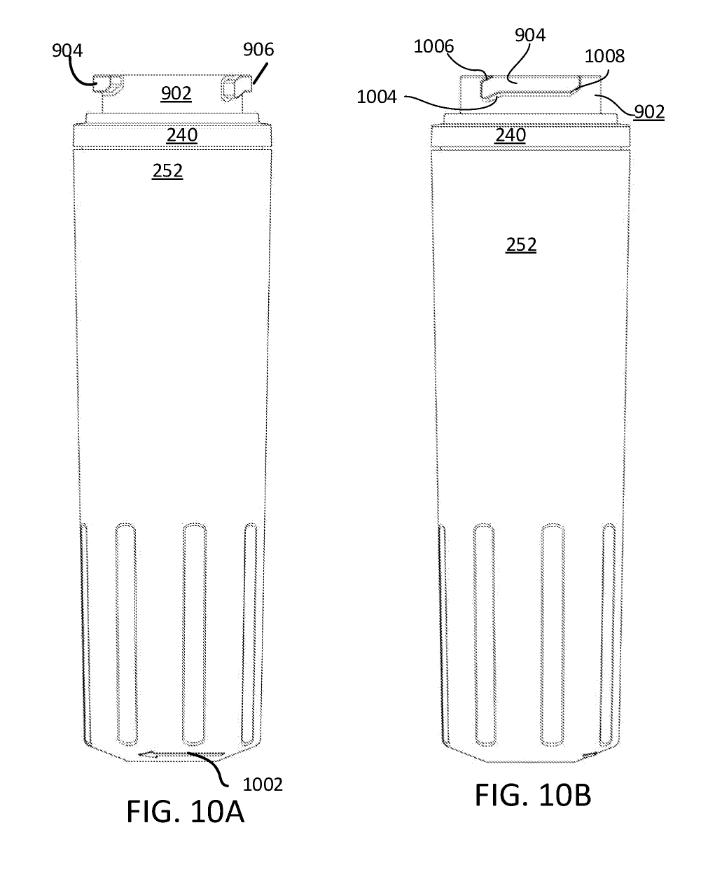

FIGS. 9-13 show diagrams of an embodiment of filter cartridge 104, which includes cover 240 and canister 252.

FIG. 9 shows a top perspective view of filter cartridge 104. FIG. 9 shows neck 902, protrusions 904 and 906, protrusion 908, hole 910, and depressions 912a, 912b, 912c, and 912d (the entire set of depression will be referred to as 912a-h).

Neck 902 is the neck of cartridge cover 240. Neck 902 engages and connects to filter head 102. Neck 902 is formed by a circular wall, which forms a depression within which are openings to input and output fluid conduits of filter cartridge 102. The depression formed within neck 902 aligns with and accepts (e.g., engages) the body of fluid distributor 232.

Protrusions 904 and 906 are located on the neck 902 of cartridge cover 240. Protrusions 904 and 906 shaped to, screw onto, engage, and connect to filter head 102. Protrusions 904 and 906 protrude radially outwards from neck 902 away from an axis parallel to and at the center of filter cartridge 104. The shapes of protrusions 904 and 906 will be discussed in conjunction with FIG. 10b. Optionally, protrusions 904 and 906 may be lugs.

Protrusion 908 protrudes upwards away from the filter element 246 of filter cartridge 104 (FIG. 1). Protrusion 908 pushes one of plugs 224 or 226 (FIG. 2) upwards unplugging the flow of fluid. Protrusion 908 is sloped on one end so as to gently push one of plugs 224 or 226 upwards as filter cartridge is rotated into place. The sloped side of protrusion 908 faces the direction into which filter cartridge 104 is rotated when attaching filter cartridge 104 to filter head 102. Hole 902 catches fluid that flows through the hole that is unplugged by protrusion 908 and fluid that flows when plugs 224 and 226 are pushed in to filter head 102 to unplug one of holes 308 and 310 (FIG. 3).

Indentations 912a-h, may be a plurality of grooves around the outside perimeter of the canister 252, which form a grip for the user to grab filter canister 252 when installing or uninstalling filter cartridge 104. Indentations 912a-h are also visible in FIG. 2. In an embodiment, the indentations 912a-h extend from the bottom edge of the canister 252 toward the cartridge cover 240 (FIG. 2). Although 8 indentations are shown in this specification, there may be any number of indentations similar to indentations 912a-h. The indentations 912a-h facilitate grasping and/or gripping the filter unit 100 and/or may be for decoration purposes. In the embodiment in FIG. 9, indentations 912a-h have a cross sectional shape that is a section of a circle (e.g., an eighth of a circle) and optionally has a partly spherical top end. Indentations 912a-h, if present, may have any of a number of shapes, such as having a cross section that is elliptical, ovular, rectangular, triangular, and/or polygonal. Similarly, the perimeter of the canister 252 may include protrusions in addition to or instead of indentations 912a-h.

FIGS. 10A and 10B show side views of an embodiment of filter cartridge 104. FIGS. 10A and 10B show another view of indentations 912a-h (which are not labeled as such in FIGS. 10A and 10B). FIG. 10A shows parts of protrusions 904 and 906, whereas FIG. 10B shows the shape of protrusion 904 (which is the same as the shape of protrusion 906). FIG. 10A shows arrow 1002, which points in the direction that filter cartridge 104 needs to be rotated to be removed from filter head 104.

Regarding FIG. 10B, slopes 1004, 1006 and 1008 may all be parallel to one another. Slopes 1004 and 1008 guide filter cartridge 104 as filter cartridge 104 is rotated into filter head 102, guiding protrusion 904 further into filter head 102, with flanges 304 and 306 under protrusions 904 and 906. Slope 606 in combination with one of slopes 510 and 512 (FIG. 5) guides protrusion 904 so as to no longer be aligned with flanges to one of notches 322 or 324 and then out of filter head 102.

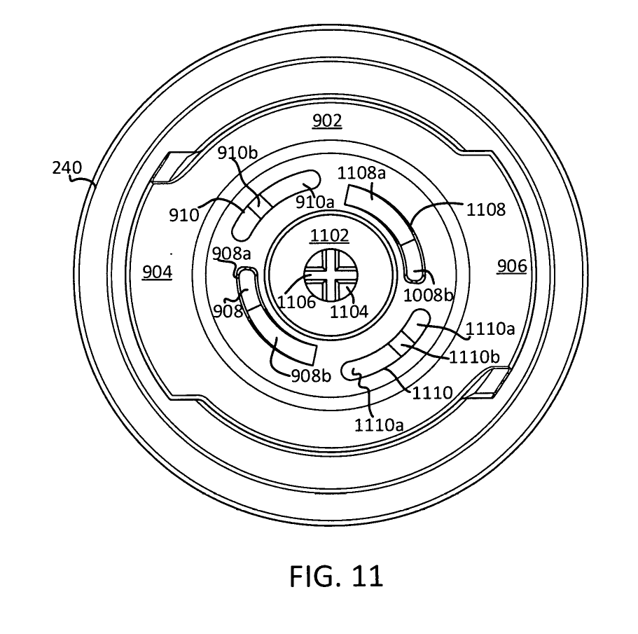

FIG. 11 shows a top view of an embodiment of cartridge cover 240, which includes neck 902, protrusion 904, protrusion 906, protrusion 908, having elevated portion 908a and sloped portion 908b, hole 910 having opening 910a and bridge 910b, depression 1102 having hole 1104, reinforcing cross piece 1106, protrusion 1108, having elevated portion 1108a and sloped portion 1108b, hole 1110 having opening 1110a and bridge 1110b.

Optionally, the top of neck 902, protrusion 904 and protrusion 906 may be flush with one another. Depression 1102 is a depression in cartridge cover 240, which extends deeper into filter cartridge 104 than the depression formed by neck 902 (FIG. 9). Depression 1102 accepts neck 232b of fluid distributor 232. Hole 1104 is an opening in the floor of depression 1102 that allows fluid to flow between a cavity in filter element 246. Protrusion 908 was described in conjunction with FIG. 9. Elevated portion 908a is the highest portion of protrusion 908, and is the part of protrusion 908 that is in contact with the head of one of plugs 224 and 226 (FIG. 2) (which is the pointy or rounded portion of plug 224 or 226), when filter cartridge 104 is attached to filter head 102. Sloped portion 908b slopes down from elevated portion 908a to an elevation closer to the filter element 246 within filter cartridge 104. Sloped portion 908b is the portion of protrusion 908 that lifts up one of plugs 224 and 226 as the filter cartridge 104 is rotated, until plugs 224 and 226 are supported by elevated portion 908a to attach filter cartridge 104, to allow fluid to flow.

Hole 910 was discussed in conjunction with FIG. 9. Opening 910a is the opening through which fluid flows. Bridge 910b is optional and may be part strut for strengthening the cartridge cover 240.

Protrusion 1108, elevated portion 1108a and sloped portion 1108b have the same shape and description as protrusion 908, elevated portion 908a and sloped portion 908b, respectively. Although slope 1008a faces the opposite direction as slope 908a, both face into the direction of rotation when attaching filter cartridge 104 to filter head 102. Hole 1110 having opening 1110a and bridge 1110b have the same description as hole 910, opening 910a and bridge 910b, respectively.

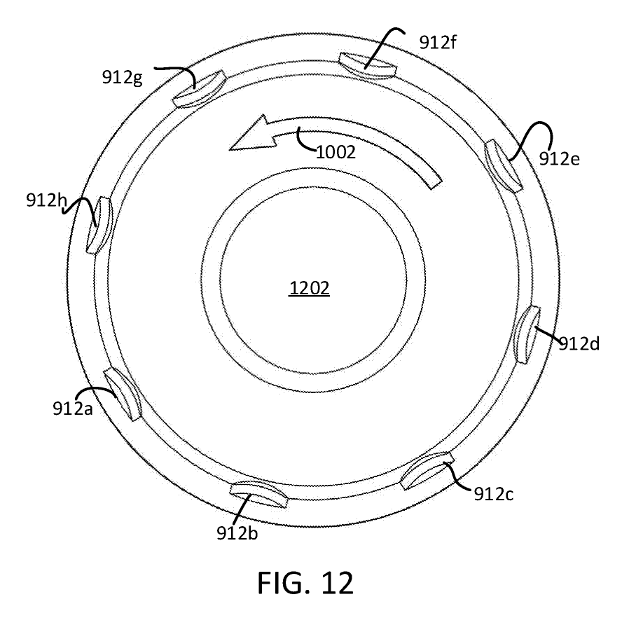

FIG. 12 is a bottom view of an embodiment of canister 252 (FIG. 2) and of filter cartridge 104 (FIG. 1). FIG. 12 shows another view of indentations 912a-h and arrow 1002 and shows depression 1202. Indentations 912a-h and arrow 1002 were discussed above in conjunction with FIGS. 9 and 10A, respectively.

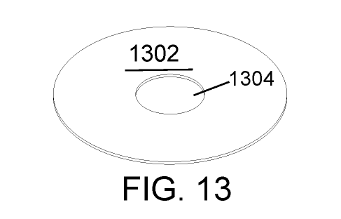

FIG. 13 shows a perspective view of filter cover 1302 having hole 1304. In other embodiments, the filter cover 1302 may not include all of the components disclosed in FIG. 13 and/or may include other components in addition to or instead of those disclosed in FIG. 13.

Filter cover 1302 may be an embodiment of filter covers 244 and/or 248. Filter cover 1302 may look the same from the top and the bottom and may be a simple disc with a hole in the center. Filter cover 1302 may have the same shape as the top and/or bottom of the filter element (e.g., circular), so as to cover the top and/or bottom filter element 246. Hole 1304 may align with a central cylindrical cavity in the filter element 246.

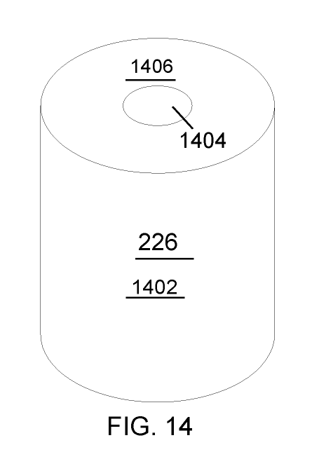

FIG. 14 shows filter element 246 and includes outer side wall 1402, cavity 1404, and top 1406. In the embodiment of FIG. 14, filter element 246 is cylindrical. Outer side wall 1402 is the outer wall of the filter element 246. Unfiltered fluid enters filter element 246 and is filtered as the fluid passes through filter element 246. Cavity 1404 is a hollow cavity in filter element 246 (e.g., at the core of filter element 246) where filtered fluid gathers after having passed through filter element 246. Cavity 1404 may also be referred to as the core of filter element 246. Neck 242a of filter cap 242 is inserted into cavity 1404 to keep filter element 246, and filter cover 244 aligned. In an embodiment, the diameter of cavity 1404 is the same as the inner diameter of filter cover 244, which are both slightly larger than the outer diameter of diameter neck 242a. In an embodiment, cavity 1404 is cylindrical and concentric with the outer wall side wall 1402. Top 1406 is the top of filter element 246. In an embodiment, top 1404 is flat and the bottom of filter element 246 is identical to the top of filter element 246. When filter cartridge 104 is assembled, top 1406 and the bottom of filter element 246 are covered with filter covers 224 and 228, respectively, preventing fluid from exiting filter element via top 1404 and the bottom of filter element 246.

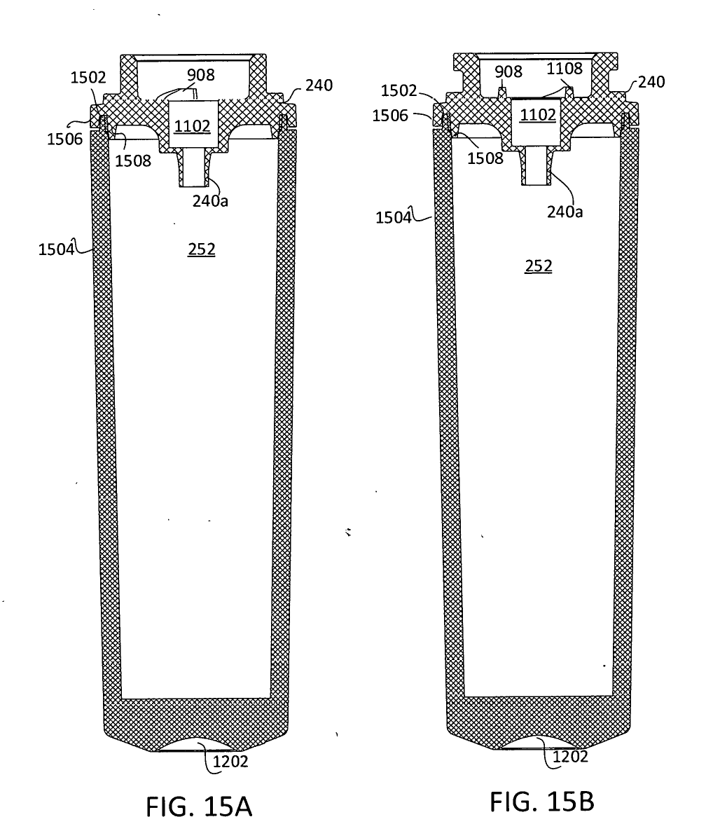

FIGS. 15A and 15B show a cross section of an empty filter cartridge. Both FIGS. 15A and 15B show cartridge cover 240 (FIG. 15A), neck 240a, canister 252, depression 1102, depression 1202, lip 1502, walls 1504, 1506, and 1508. However, FIG. 15A only shows protrusion 908, whereas FIG. 15B shows protrusions 908 and 1108.

FIGS. 15 A and B show the depth of an embodiment of depressions 1102 and 1202. However, depressions 1102 and 1202 may be a variety of depths. Depression 1202 is optional.

Lip 1502 rises above wall 1504 of canister 252. Lip 1502 may engage cartridge cover 240 to aid in forming a seal. Walls 1506 and 1508 of cartridge cover 240 form an annular cannel in which lip 1502 is inserted. In this specification, any part that is intended to form a seal with an o-ring or another component so that fluids will not leak may be made from a nonporous material, such as plastic or metal. Some non-limiting examples of nonporous plastics that may be used for lip 1502, wall 1506, wall 1508, and/or other components (e.g., wall 1504) used for creating a seal are Polyethylene Terephthalate (PET), High-Density Polyethylene (HDPE), Acrylonitrile Butadiene Styrene (ABS), Polyvinyl Chloride (PVC) or Polypropylene (PP). Optionally, lip 1502, wall 1506, wall 1508 may be welded to one another, melted to one another, and/or soldered to one another, glued to one another. Optionally, lip 1502, wall 1506, and wall 1508 may be friction fit to one another requiring lip 1502, wall 1506, and/or wall 1508 to flex slightly in order for lip 1502 to fit into the channel formed by walls 1506 an 1508. Optionally, lip 1502, wall 1506, and wall 1508 are melted, adhered, glued, soldered, welded or otherwise attached together.

In other embodiments, cartridge cover 240 and canister 252 may additionally, or alternatively, attach to one another in another way (other than via lip 1502 fitting into a channel formed by walls 1506 and 1508), such as via screw threads, snaps, rivets, clasps, buttons or screws.

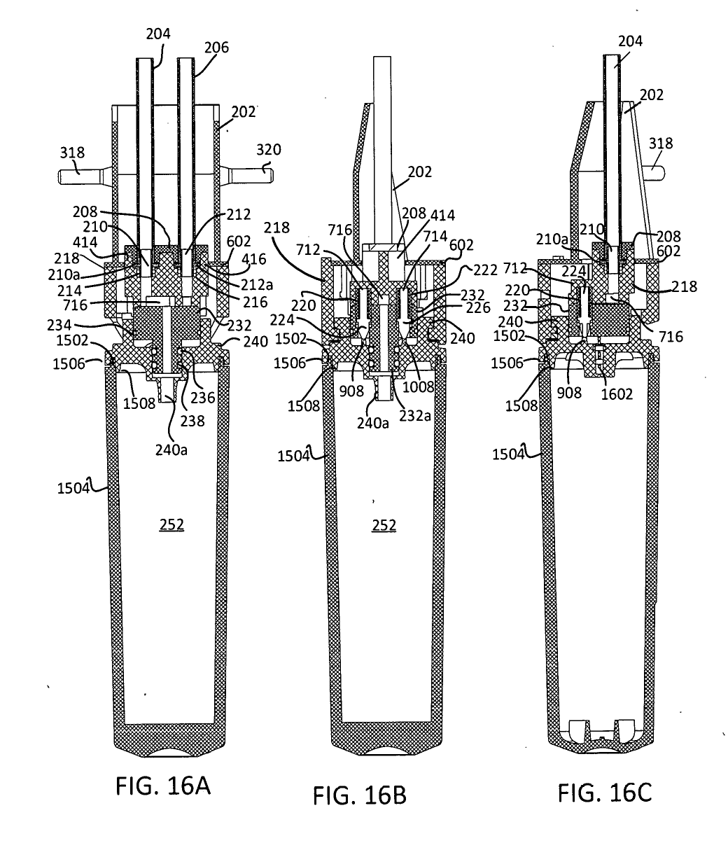

FIGS. 16A-C show different cross sections of filter system 100.

FIGS. 16A-C show guard 202, output conduit 206 (FIG. 16A), input conduit 204, (FIGS. 16A and 16C), mask 208, o-rings 214 and 216, (FIG. 16A), manifold 218, spring 220 (FIGS. 16B and 16C), spring 222 (FIGS. 16A and 16B), plug 224 (FIGS. 16B and 16C), plug 226(FIGs. 16A and 16B), fluid distributor 232 having neck 232b, o-rings 234, 236, and 238 (FIG. 16A), cartridge cover 240 (FIG. 16C) having neck 240a (FIG. 16A and 16B), canister 252, well 414, base 602, channel 716, lip 1502, walls 1504-1508.

FIGS. 16A and B also show FIGS. 16A also shows arms 318 and 320, and well 416. FIGS. 16B and C show tubular ring 210 and collar 210a, well 712, and protrusion 908. FIG. 16B additionally shows well 714 and protrusion 1008. FIG. 16B also shows tubular ring 212 having collar 212a. FIG. 16C shows conduit 1602. Conduit 1602 is a connected to hole 910. Opening 910a opens into conduit 1602.

FIG. 16A shows a cross section along a cut line that cuts through the middle of input conduits 204 and 206. FIG. 16B shows a cross section that cuts through the middle of plugs 224 and 226, which is perpendicular to the cut line of FIG. 16A. FIG. 16C is a cross section along a cut line that cuts through tubular ring 210 and plug 224, which is a line that is not parallel to the either of the cut lines of FIG. 16A and 16B.

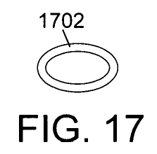

FIG. 17 shows a perspective view of o-ring 1702, which may be an embodiment of any combination of, or all of, o-rings 214, 216, 228, 230, 234, 236, and/or 238. O-ring 1702 may be donut shaped, for example, have a circular cross section. In other embodiments, o-ring 1702 may have another cross-sectional shape, such as ovular, square, rectangular, triangular, for example. In other embodiments, the o-ring 1702 may not include all of the components listed and/or may include other components in addition to or instead of those listed above.

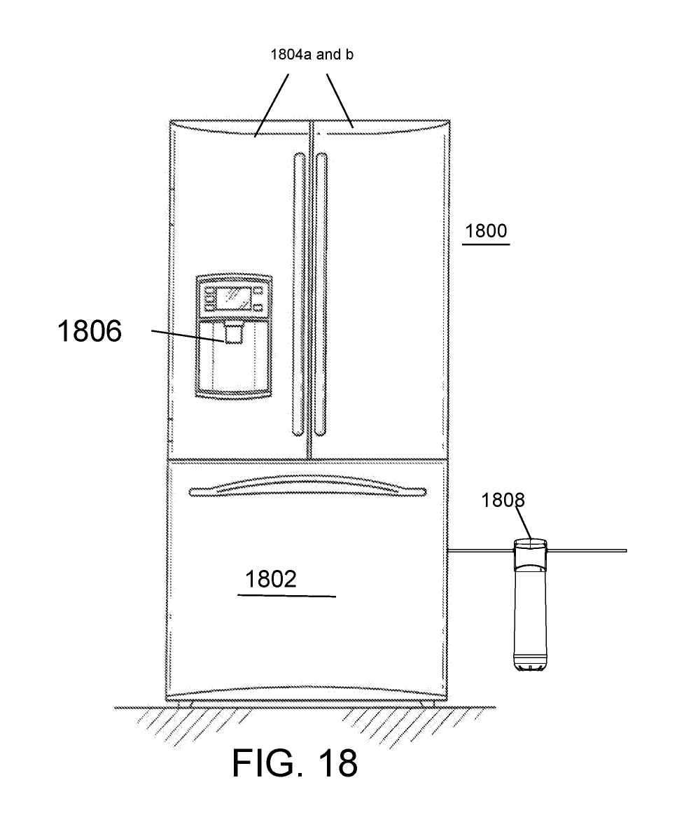

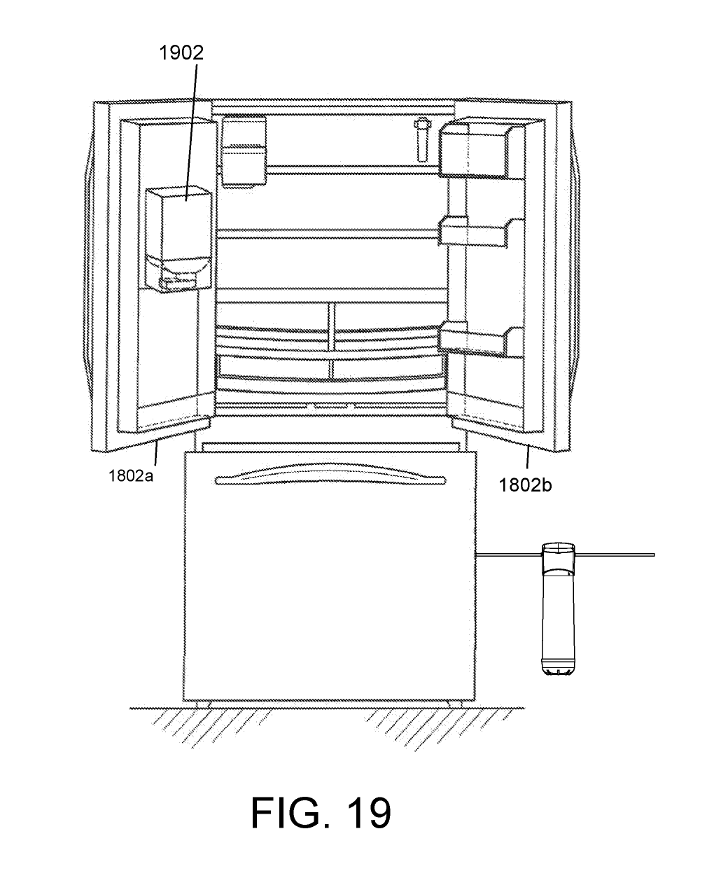

FIGS. 18 and 19 show refrigerator filter system 1800 having refrigerator 1802, doors 1804a and b, water dispenser 1806, and outside filter 1808. In other embodiments, refrigerator filter system 1800 may not include all of the components disclosed in FIGS. 18 and 19 and/or may include other components in addition to or instead of those disclosed in FIGS. 18 and 19.

In the embodiment of FIG. 18, water dispenser 1806 is installed in door 1804a, which dispense water (or another fluid) from filter system 104 (FIG. 1). Water dispenser 1806 may include any of the embodiments of water system 100. Water from output conduit 206 (FIG. 2) is dispensed via water dispenser 1806. In other embodiments, filter system 100 may be installed elsewhere in refrigerator 1800 (e.g., door 1802b). Outside filter 1808 receives water form a water source (e.g., via hoses, pipes, or other conduits) and is attached to refrigerator 1800 (e.g., also via hoses, pipes, or other conduits). Outside filter 1808 filters water entering refrigerator 1800 and is therefore attached (e.g., indirectly) to input conduit 204 (FIGS. 2). Outside filter 1808 may has the same or similar construction as system 100 or as any of the filters of U.S. patent application Ser. No. 15/166,231 (Docket NO. CO-1), entitled “Reusable Filter System,” by Zhibin Zou, filed May 26, 2016, U.S. patent application Ser. No. 29/564,197 (Docket No. CO-2), entitled “Filter Unit,” by Zhibin Zou, filed May 11, 2016, U.S. patent application Ser. No. 29/564,255 (Docket No. CO-3), entitled “Filter Unit,” by Zhibin Zou, filed May 11, 2016, U.S. patent application Ser. No. 29/564,262 (Docket No. CO-4), entitled “Filter Unit,” by Zhibin Zou, filed May 11, 2016, and U.S. patent application Ser. No. 29/564,270 (Docket No. CO-5), entitled “Filter Unit,” by Zhibin Zou, filed May 11, 2016; U.S. patent application Ser. No. 15/194,441 (Docket No. CO-6), entitled “Reusable Filter System,” by Zhibin Zou, filed Jun. 27, 2016; Ser. No. 15/200,697 (Docket No. CO-10), entitled “Water Filter,” by Zhibin Zou, filed Jul. 1, 2016; U.S. patent application Ser. No. 15/200,697 (Docket No. CO-10), entitled “Water Filter,” by Zhibin Zou, filed Jul. 1, 2016; or U.S. patent application Ser. No. 15/945,234 (Docket No. CO-22), entitled “Filter System,” by Zhibin Zou, filed Apr. 4, 2018. However, outside filter 1808 filters heavy metals and lasts longer than the filter installed in refrigerator door 1804a

FIG. 19 shows refrigerator filter system 1800 with doors 1804a and b opened. In the embodiment of FIG. 19, filter system 100 is installed on the inside of door 1804a near water dispenser 1806.

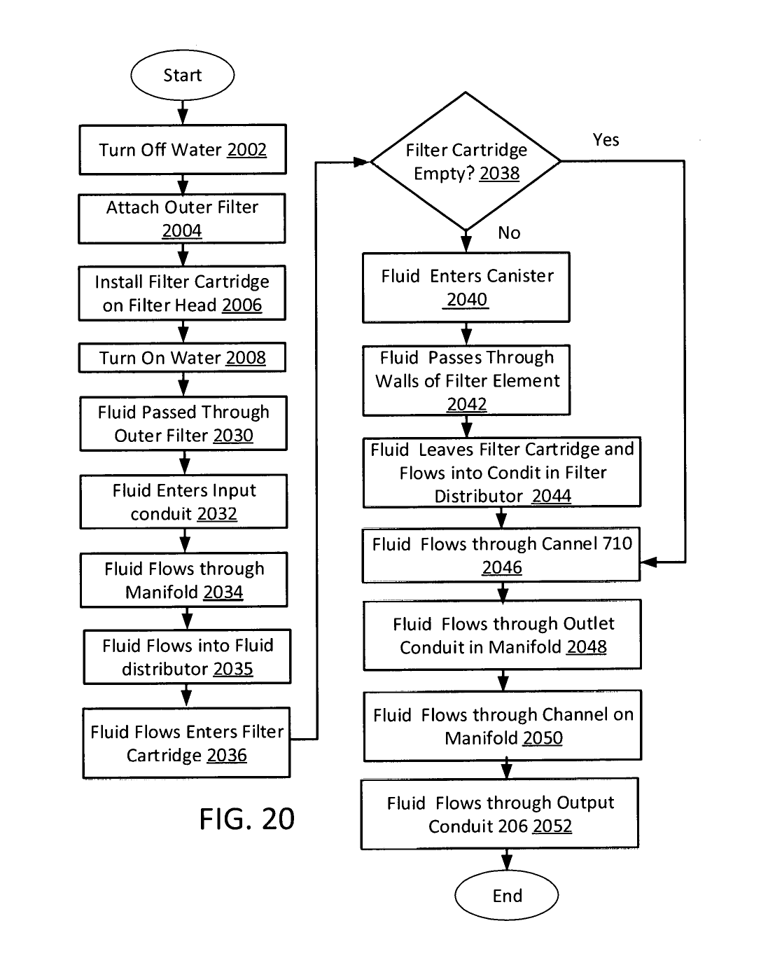

The fluid filter system 100 mentioned in FIGS. 20-22 may be any of the embodiments of the fluid filter systems in this specification.

### Method of Use

FIG. 20 is a flowchart of an embodiment of a method 2000 of using the fluid filter system 1800.

In step 2002, water is turned off

In step 2004, outer filter 1808 is attached to the input water hose of filter system 1800 (if outer filter 1808 has not been constructed, outer filter 1808 is first constructed).

In step 2006, filter cartridge 104 is installed onto filter head 102 of filter system 100 (at any time prior to step 2006, if filter head has not been constructed yet and/or has not been installed in refrigerator 1802, filter head 102 is constructed and/or installed, and if filter cartridge 104 is not constructed yet, filter cartridge 104 is constructed). Filter cartridge 104 may be installed with or without top filter cap 242, filter cover 244, filter element 246, filter cover 248 and bottom filter cap 250. Steps 2004 and 2006 may be performed in any order.

In step 2008 the water is turned on and the water dispenser 1806 is activated (if the filter head 104 has an automatic shutoff valve, the water does not necessarily need to be turned off).

In step 2030, fluid passes through outer filter 1808 and is filtered for heavy metals. In step 2032, the filtered water then passes into refrigerator 1802 to input conduit 204.

In step 2032, the fluid passes into filter head 102, through input conduit 204, and from input conduit 204 through tubular ring 210 into manifold 218.

In step 2034, in an embodiment, while in manifold 218 the fluid passes through inlet 702 to channel 710.

In step 2035, then fluid flows from manifold 202 and channel 710 into channels 802 and 804 of fluid distributor 232.

In step 2036, the fluid from channels 802 and 804, exits via holes 308 and 310, the fluid distributor into the neck of cartridge cover 240.

As indicated by decision box 2038, if top filter cap 242, filter cover 244, filter element 246, filter cover 248 and bottom filter cap 250 are present, then the method 2000 proceeds to step 2040. In an embodiment, the decision of decision box 2038 occurs automatically as a direct result of whether filter cartridge 104 is empty or top filter cap 242, filter cover 244, filter element 246, filter cover 248 and bottom filter cap 250 are present.

In step 2040, then via holes 910 and 1110, of cartridge cover 240, the fluid enters into canister 252. Specifically, from holes 910 and 1110, fluid flows into the space between wall 1402 of filter element 246 and canister 252.

In step 2042, the water under the pressure of the incoming water passes through filter element 246 and is filtered. In an embodiment, the water passes through filter element 246 and fills the space filter element 246 and the inner surface of wall 1504 of canister 252 and then seeps through the wall of filter element 246 into cavity 1404 of filter element 246. In an embodiment, as part of step 2042, filter covers 244 and 248 keep fluid from entering filter element 246 out of the top or bottom before leaving filter element 246, where filter covers 244 and 248 are held in place by top filter cap 242 and top filter cap 250 (which in turn are held together by canister 252 and cartridge cover 236).

In step 2044, when/if the water height is high enough, water from cavity 1404 within filter element 246 flows into neck 240a. When the water is first turned on, the water may need to first fill the cavity 1404 before leaving cavity 1404. After filter system 100 has already been used, cavity 1404 may already be full, and immediately upon turning on the water, some water travels from cavity 1404 of filter element 246 into neck 240a and neck 232b.

In step 2046, fluid from neck 240a enters into hole 302 up neck 232a of filter distributor 232.

In step 2048, water from the conduits in filter distributor 232 proceeds into channel 716 in manifold 218. The water is held in channel 716, in part by a surface of fluid distributor 232 that closes the open side of channel 716.

In step 2050, the fluid from channel 716 enters outlet channel 704.

In step 2052, the fluid proceeds from outlet channel 704 into tubular ring 212 and then leave the filter have via output conduit 206. If the fluid is a water and the filter system 100 is part of refrigerator 2702, the water may be dispensed (e.g., into a cup). In step 2052, water passes from filter head 104 (e.g., from output conduit 206) through output hoses and leaves the refrigerator 1802 (e.g., into a cup in the water dispenser 1806).

Returning to decision box 2038, if filter cartridge 104 is empty (e.g., if filter cap 242, filter cover 244, filter element 246, filter cover 248 and cap 250 are not present), then the method skips steps 2040-2044, and the method proceeds to step 2046, where, if the filter system 100 is being used for the first time after being installed and turning on the water, the water may fill canister 252. Once canister 252 is full, water flows from canister 252 into filter head 102 (e.g., and the water flows up tubular extension 206b). If the filter system 100 was previously used, canister 252 may already be full, and water may start flowing from canister 252, via neck 240a into filter head 102.

In an embodiment, each of the steps of method 2000 is a distinct step. In another embodiment, although depicted as distinct steps in FIG. 9, steps 2002-2052 may not be distinct steps. In other embodiments, method 900 may not have all of the above steps and/or may have other steps in addition to or instead of those listed above. The steps of method 2000 may be performed in another order. Subsets of the steps listed above as part of method 2000 may be used to form their own method.

### Method of Assembly of Filter Cartridge

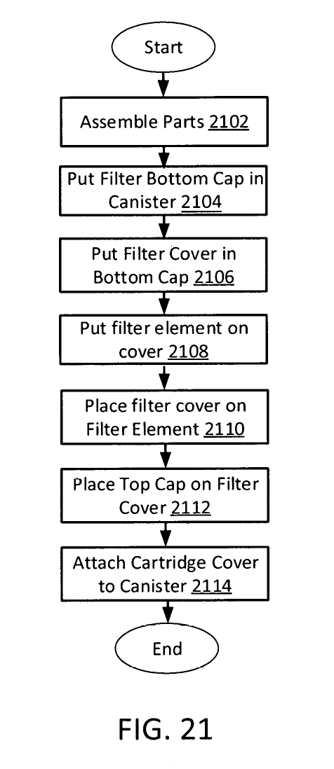

FIG. 21 is a flowchart of an embodiment of a method 2100 of making the fluid filter cartridge 104.

In step 2102, bottom cap 250, canister 252, filter cover 248, filter element 246, filter cover 244, fluid distributor 224, cartridge cover 240, o-ring 220, and o-ring 218 (FIG. 2) are formed.

In step 2104, the bottom cap 250 is placed in canister 252 (FIG. 2). In step 2106, filter cover 248 is placed in bottom cap 250, and optionally filter cover 248 is placed in a location such that hole 2004 (FIG. 20) in the middle of filter cover 248 engages tubular extension 250a, so that tubular extension 250a protrudes through hole 2004. In step 2108, filter element 246 is placed on filter cover 248, and optionally tubular extension 250a protrudes into cavity 1404. In step 2110, filter cover 244 is installed, such as by placing filter cover 244 on top surface 1406 of filter element 246, with hole 2004 aligned with the opening to cavity 1404 (FIG. 14).

In step 2112, top cap 242 is placed on top of filter cover 244, such that neck 242a extends through and engage hole 1304 of filter cover 244 and cavity 1404 and wall 242b of top cap 242 extends over the side 1402 of filter element 246, thereby engaging filter element 246. As part of step 2112, spacers attached to top cap 242 may be placed within canister 252, and my aid in maintaining a distance between filter cap 242 and the inner wall of canister 252. In step 2114, cartridge cover 240 is placed on top of canister 252 and sealed. As part of step 2114, lip 1502 of canister 252 is placed between walls 1506 and 1508 (FIG. 13) of cartridge cover 240, and sealed together. As part of step 2114, neck 240a (FIG. 2) is inserted into tubular portion 242a (FIG. 2) and optionally cartridge cover 240 presses on the top of top cap 242, which places a small amount of pressure on filter cover 244, filter element 246, filter cover 248, and top cap 242, thereby holding top cap 242, filter cover 244, filter element 246, filter cover 248, and bottom cap 250 together so water does not exit through the top or bottom of filter element 246. In an alternative embodiment, top cap 242, filter cover 244, filter element 246, filter cover 248, and bottom cap 250 are not placed in filter cartridge 104, and steps 2104 to 2112 may be skipped.

Step 2114, may only include forming canister 252 and cartridge cover 240, for example and step 2114 may include placing lip 1502 of canister 252 between walls 1506 and 1508 (FIG. 13) of cartridge cover 240, and sealing canister 252 and cartridge cover 240 together.

In an embodiment, each of the steps of method 2100 is a distinct step. In another embodiment, although depicted as distinct steps in FIG. 21, steps 2102-2114 may not be distinct steps. In other embodiments, method 2100 may not have all of the above steps and/or may have other steps in addition to or instead of those listed above. The steps of method 2100 may be performed in another order. Subsets of the steps listed above as part of method 2100 may be used to form their own method.

### Method of Assembly of Filter Head of Filter

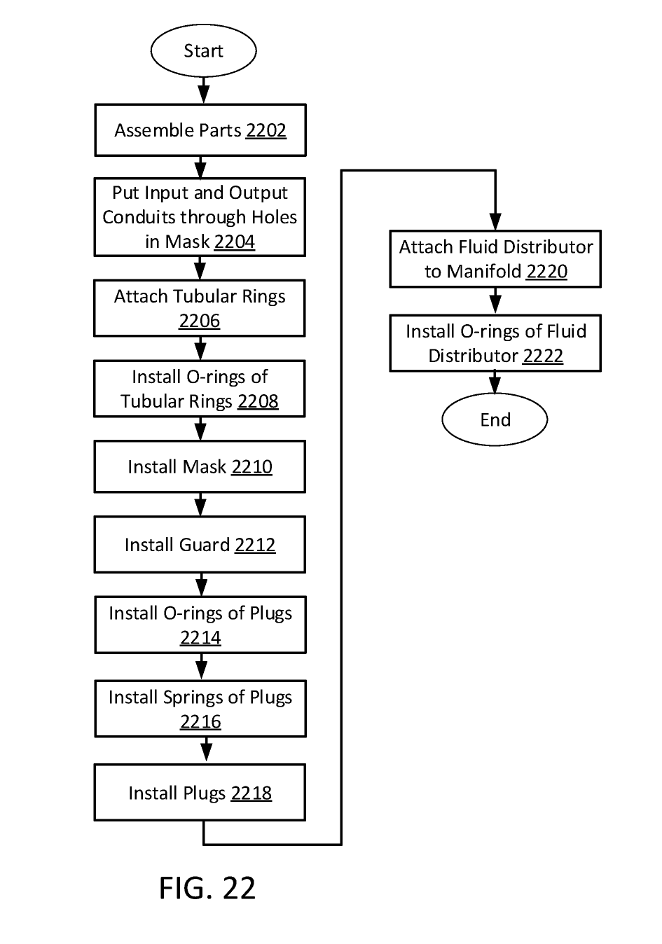

FIG. 22 is a flowchart of an embodiment of a method 2200 of making the fluid filter system 100.

In step 2202, guard 202, input conduit 204, output conduit 206, mask 208, tubular rings 210 and 212 having collars 210a and 212a, respectively, o-rings 214 and 216, manifold 218, springs 220 and 222, plugs 224 and 226, o-rings 228 and 230, fluid distributor 232 having neck 232b, o-rings 234, 236, and 238 (FIG. 2) are assembled and/or provided.

In step 2204, input conduit 204 and output conduit 206 are inserted through holes in mask 208. In step 2206, tubular rings 210 and 212 are inserted into input conduit 204 and output conduit 206 (while mask 208 is on input conduit 204 and output conduit 206). As part of step 2206, the end of tubular rings 210 and 212 having tapered head 720 is inserted into input conduit 204 and output conduit 206.

In step 2208, in an embodiment, o-rings 228 and 230 are placed on tubular rings 210 and 212 or inlet conduit 702 and outlet conduit 704. In another embodiment, as part of step 2208, o-rings 228 and 230 are placed on ledges 710 and 712 (FIG. 7B) within inlet conduit 702 and outlet conduit 704 (FIG. 7A) of manifold 218 (step 2208 may be performed prior to step 2204, for example). In other words, as part of step 2208, tubular rings 210 and 212 are inserted into manifold 218. Step 2208 may include inserting tubular rings 210 and 212 into inlet conduit 702 and outlet conduit 704 (FIG. 7A), which in-turn includes placing the end of body 722 that is opposite tapered head 720 (FIG. 7C) into inlet conduit 702 and outlet conduit 704, with collars 210a and 212a resting on ledges 706 and 708 (FIG. 7B) and end of body 722 that is opposite tapered head 720 (FIG. 7C) resting on ledges 710 and 712 or on o-rings 214 and 216, which in turn rest on ledges 710 and 712 (FIG. 7B).

In step 2210, optionally, mask 208 is installed. Mask 208 may be glued, adhered, melted, or soldered onto the rims of input conduit 204 and output conduit 206. Alternatively, input conduit 204 and output conduit 206 may be placed within mask 208 prior to attaching tubular rings 210 and 212 and attaching tubular rings 210 and 212 to manifold 218.

In step 2212, guard 202 is attached to manifold 218, which may include inserting legs 202a, 202b and any other legs of guard 202 into manifold 218, such that tabs at the end of legs 202a and 202b are inserted into holes 318, 320 (FIGS. 3 and 4C), 402 and 404 (FIG. 4A) and inserting tab 412 into slot 602 (FIG. 6). Additionally, as part of step 2212, input conduit 204 and output conduit 206, mask 208, inlet conduit 702, and outlet conduit 704 (FIG. 7A) are inserted through opening 604 in base 602 (FIG. 6), while base 602 rests on the rim of manifold 218 (which has tab 412).

In step 2214, o-rings 228 and 230 are placed on plugs 224 and 226 or conduits in fluid distributor 232.

In step 2216, springs 220 and 222 are placed on tubular ends of plugs 224 and 226, which face manifold 218.

In step 2218, plugs 224 and 226 are inserted into conduits in fluid distributor 232.

In step 2220, fluid distributor 232 is attached to manifold 218, such that springs 220 and 222 and the ends of plugs 224 and 226 having springs 220 and 222 are inserted into wells 712 and 714 and with one end of channel 716 (FIG. 7B) being aligned with the conduit in the center of fluid distributor 232.

In step 2222, the O-rings of the fluid distributor 232 are attached to the fluid distributor 232. Step 2220 and 2222 may be performed in any order.

In an embodiment, each of the steps of method 2200 is a distinct step. In another embodiment, although depicted as distinct steps in FIG. 10, steps 2202-2222 may not be distinct steps. In other embodiments, method 2100 may not have all of the above steps and/or may have other steps in addition to or instead of those listed above. The steps of method 2200 may be performed in another order. Subsets of the steps listed above as part of method 2200 may be used to form their own method.

### Plug

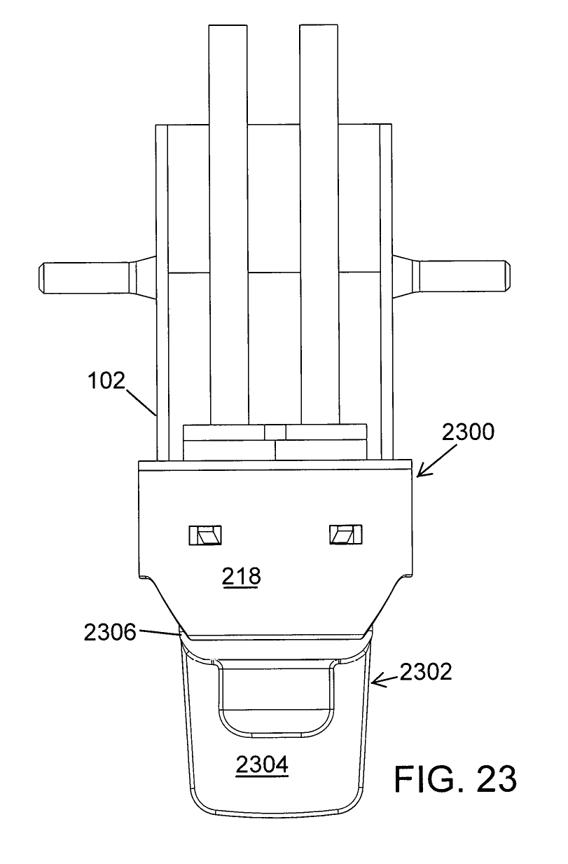

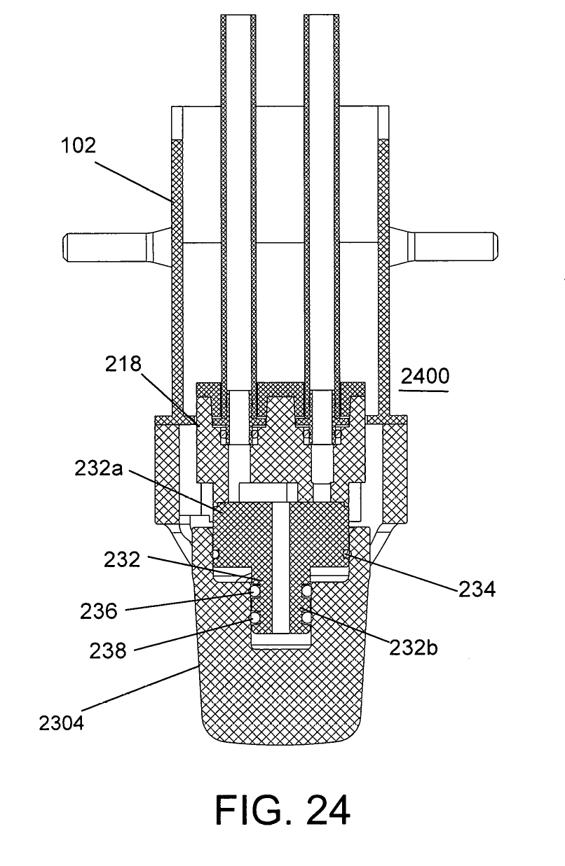

FIG. 23 shows another embodiment 2300 in which a plug is attached to the inside filter head instead of the inside filter cartridge of FIGS. 1-15B. Embodiment 2300 includes filter head 102, and plug 2302 having handle 2304 and base 2306. In other embodiments, plug 2302 may not include all of the components listed and/or may include other components in addition to or instead of those listed above.

In FIG. 23, plug 2302 is attached to filter head 102. Handles 2304 may be a flange extending from the base of plug 2302, which a user may grab onto and turn to attach to detach plug 2302 from filter head 102. Base 2306 is the base of plug 2302, which interlocks with the base of filter head 102. Base 2306 forms a seal with filter head 102, so that water entering filter head 102 exits filter head 102 without spilling or leaking (base 2304 has a sealing function to prevent leaks).

FIG. 24 shows a first cross sectional view 2400 of an embodiment of the plug 2302 attached to the filter head 102. Cross sectional view 2400 includes fluid distributor 232, base 232a, neck 232b, o-rings 234, 236, and 238, and handle 2304. In other embodiments, view 2400 may not include all of the components listed and/or may include other components in addition to or instead of those listed above.

The cutline for FIG. 24 is through the middle of, and in a direction parallel to handle 2304. In FIG. 24, the inner walls of plug 2302 hug neck 232b of fluid distributor 232, forming a seal with o-rings 236 and 238 and optionally hug base 232a of fluid distributor 232, forming a seal with o-ring 234, so as to prevent water from leaking (however, since both the incoming water and outgoing water flow through neck 232b of water distributor 232, the water should be prevented from leaking by either of o-rings 236 or 238, so that each of o-rings 234, 236 and 238 are optional—only one of the three o-rings is necessary).

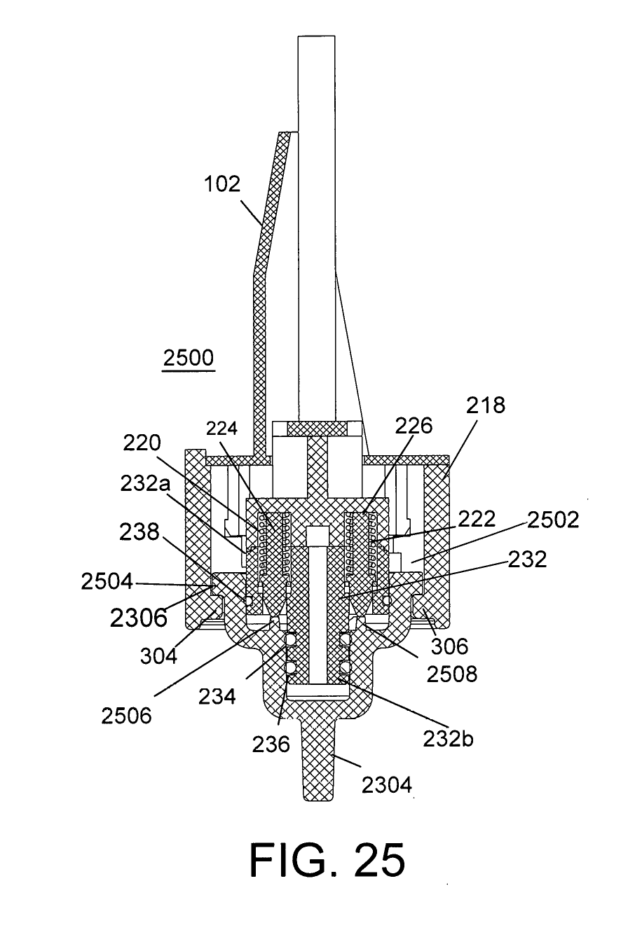

FIG. 25 shows a second cross sectional view 2500 taken along a cut line that is perpendicular to the cutline of the FIG. 24 of an embodiment of the plug 2302 attached to the filter head 102. Cross sectional view 2500 includes (among other things) filter head 102, manifold 218, springs 220 and 222, plugs 224 and 226, fluid distributor 232, base 232a, flanges 304 and 306, walls 326, plug 2302, handle 2304, base 2306, flanges 2502 and 2504, and sloped protrusions 2506 and 2508. In other embodiments, view 2500 may not include all of the components listed and/or may include other components in addition to or instead of those listed above.

The cutline of FIG. 25 passes through the middle of handle 2304 and perpendicular to handle 2304. Flanges 2502 and 2504 extend away from the base 2306 of plug 3202, and interlock with flanges 304 and 306, respectively, on the inner side of walls 326 of manifold 218 within filter head 102. Specifically, flanges 2502 and 2504 may press against flanges 304 and 306, preventing the plug 2502 from being pulled out of filter head 102 (unless plug 2502 is rotated so that flanges 2502 and 2504 no longer align with flanges 304 and 306), while base 232a of fluid distributor 232 pushes against the top of the inner side of base 2306, preventing plug 2302 form being pushed further into filter head 102. Sloped protrusions 2506 and 2508 push up against plugs 224 and 226 compressing springs 220 and 222, holding holes 306 and 308 open, so that water can enter and leave filter head 102.

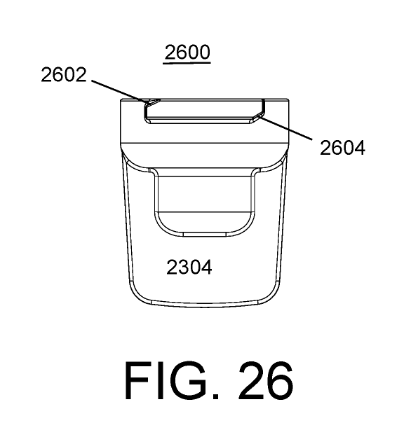

FIG. 26 shows a side view 2600 of an embodiment of the plug 2302. Side view 2600 shows (among other things) manifold 218, flanges 2502 and 2504, and beveled edges 2602 and 2604. In other embodiments, view 2600 may not include all of the components listed and/or may include other components in addition to or instead of those listed above.

Side view 2600 shows a side view of one of flanges 2502 and 2504, which both have the same profile. Flanges 2502 and 2504 have one sloped or beveled edge 2602 at a corner on the side of the flanges 2502 and 2504 that faces towards the manifold 218 and a second sloped edge or beveled edge 2604 facing away from manifold 218 at a corner of flanges 2502 and 2504 that is diagonally opposite the other sloped or beveled edge 2602. Sloped or beveled edge 2602 that faces towards the manifold 218 guides plug 2302 out of filter head 102, while plug 2302 is rotated in one direction and the second sloped edge or beveled edge 2604 facing away from manifold 218 guides plug 2302 into filter head 102, when plug 2302 is rotated in the opposite direction.

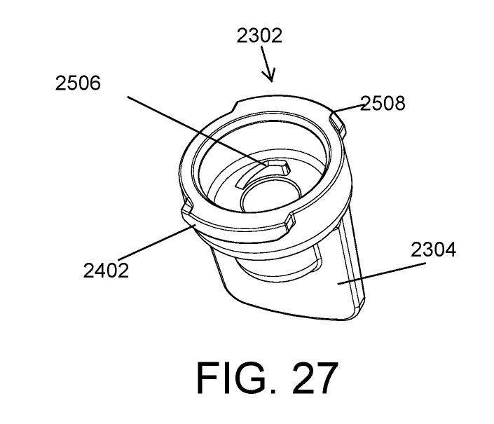

FIG. 27 shows a perspective view of an embodiment of the plug 2302. FIG. 27 shows (among other things) parts of the inside of plug 2302 having one of sloped protrusions 2506 and 2508 (2508 is not visible in FIG. 27). In other embodiments, view 2700 may not include all of the components listed and/or may include other components in addition to or instead of those listed above. In FIG. 27, one of sloped protrusions 2506 and 2508 is visible. In an embodiment, sloped protrusions 2506 and 2508 are located 180 degrees apart along a circle centered on at the centered of plug 2302, and face the same direction along that circle. The sloped portion 2702 aids in gently pushing up plugs 224 and 226, while turning installing plug 2302 in place.

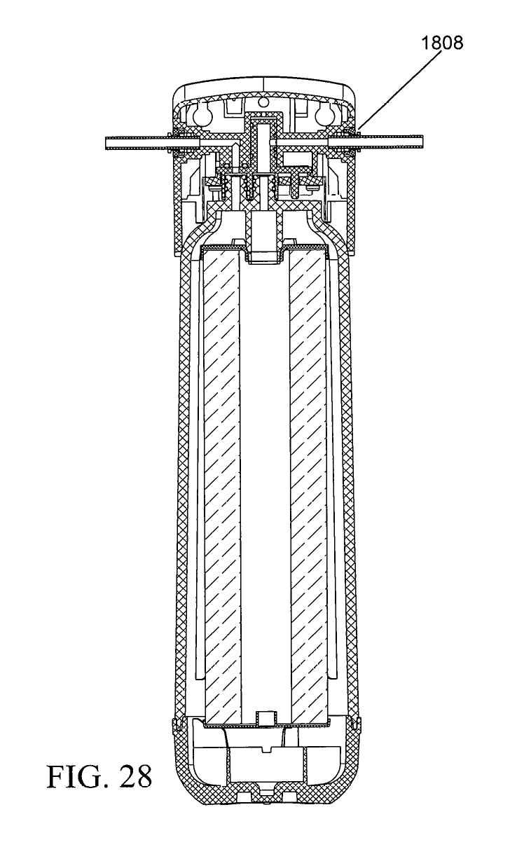

FIG. 28 shows the cross sectional view of the outside filter 1808 of FIG. 18. In an embodiment, the filter element 1808 is effective in filtering out of drinking water cadmium, mercury, lead, and/or arsenic optionally to safe levels. Additionally, or alternatively, in an embodiment, the filter element 2708 is effective in filtering out of drinking water beryllium, aluminum, chromium, manganese, iron, cobalt, nickel, copper, zinc, arsenic, selenium, molybdenum, silver, cadmium, tin, antimony, barium, mercury, thallium, and/or lead optionally to safe drinking levels.

### Alternatives and Extensions

Although this specification uses a refrigerator as an example of an appliance and a water as an example of a fluid, any appliance that requires a filtered fluid may be substituted for the refrigerator and any fluid may be substituted for water.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A system comprising:
at least an outside filter that is for installing outside of an appliance, the outside filter being effective for removing heavy metals from water; and
an inside cartridge for installing on a filter head that is within the appliance;
the inside cartridge including one or more surfaces, which when the inside cartridge is installed, holds at least one valve on the filter head open.

2. The system of claim 1, the one or more surfaces being located on one or more protrusions on a cover of the inside cartridge.

3. The system of claim 2, the protrusion having a flat surface at one end that faces the filter head when the inside cartridge is connected to the filter head, and at least one side sloping from the flat surface towards the inside cartridge.

4. The system of claim 1, the inside cartridge including an inside filter element having a filter material that is not effective in removing heavy metals.

5. The system of claim 1, the inside cartridge further comprising a cartridge cover having one or more holes around sides of the cartridge, and an opening in a center of the cartridge cover.

6. The system of claim 5,
the outside filter being mounted outside of a refrigerator;
the inside filter cartridge being installed inside of the refrigerator downstream from the first filter;
the inside cartridge including at least
an inside filter element having a filter material that is not effective in removing heavy metals;
a cartridge cover having a neck, the neck having a channel on a side of the neck for accepting fluids and an opening at the top of the neck for fluids to exit;
a canister that attaches to the cartridge cover;
a first cap that is located between the filter element and an end of the canister that is opposite an end of the canister where the cartridge cover is attached
a second cap that is located between the filter element and the cartridge cover.

7. The system of claim 6 further comprising:
a first filter cover between the first cap and the inside filter element; and
a second filter over between the second cap and the inside filter element.

8. The system of claim 1 the inside cartridge having no filter.

9. The system of claim 1 further comprising a filter head configured for installing in the refrigerator, the filter head being configured to mate with the inside cartridge, the filter head having at least one valve is held open by the inside cartridge, and closes when the inside cartridge is detached.

10. The system of claim 9, the filter head further comprising:
a manifold having a well for accepting a spring for biasing a plug to a closed position, an inlet conduit;
an outlet conduit; and
a channel connected to one of the inlet conduit or outlet conduit, the well being located in the channel.

11. The system of claim 10, the filter head further comprising
a filter distributor that connects to the manifold, the filter distributor covering one side of the channel.

12. The system of claim 11, the filter distributor including an output channel and an input channel, the plug occupying the input channel.

13. The system of claim 12, the filter head further comprising a mask attached to an input conduit, an output conduit and the mask covering the inlet conduit and outlet conduit of the manifold.

14. The system of claim 13, further comprising a guard covering an end of manifold opposite and end of the manifold to which the fluid distributor is connected.

15. The system of claim 14, further comprising a tubular ring that connects one of the input conduits and output conduits to one of the input inlet and outlet conduit, respectively.

16. A method comprising:
installing at least a filter that is outside of an appliance, effective for removing heavy metals from water; and
installing a cartridge on a filter head that is within the appliance, the filter head within the appliance being downstream from the filter that is outside of the appliance, such that fluids entering the appliance is first filtered by the filter outside of the appliance and then pass the cartridge installed within the appliance;
holding at least one valve on the filter head open, by keeping the cartridge attached to the filter head.

17. A system comprising:
at least a filter that is for installing outside of an appliance, the filter being effective for removing heavy metals from water; and
a bypass cap for installing on a filter head that is within the appliance;
the bypass cap including one or more surfaces, which when the bypass cap is installed holding at least one valve on the filter head open.
